(19) United States
(12) Patent Application Publication
(10) Pub. No.: US 2026/0204469 A1
(43) Pub. Date: Jul. 16, 2026

(54) INDUCTOR COMPONENT, MANUFACTURING METHOD FOR INDUCTOR COMPONENT, AND SUBSTRATE FOR INDUCTOR COMPONENT MANUFACTURING

(71) Applicant: Murata Manufacturing Co., Ltd., Kyoto-fu (JP)

(72) Inventors: Yoshimasa YOSHIOKA, Nagaokakyo-shi (JP); Yuuki KAWAKAMI, Nagaokakyo-shi (JP); Keisuke KUNIMORI, Nagaokakyo-shi (JP)

(73) Assignee: Murata Manufacturing Co., Ltd., Kyoto-fu (JP)

(21) Appl. No.: 19/560,553

(22) Filed: Mar. 9, 2026

Related U.S. Application Data
(63) Continuation of application No. PCT/JP2024/015296, filed on Apr. 17, 2024.

(30) Foreign Application Priority Data
Sep. 20, 2023 (JP) 2023-152732

(51) Int. Cl. H01F 27/28; H01F 41/04

(52) U.S. Cl. CPC H01F 27/2804; H01F 41/041; H01F 2027/2809

(57) ABSTRACT

An inductor component includes an element body, a first insulating layer, and an inductor wiring line including a wiring body and a protruding portion protruding from an outer surface of the wiring body on a third negative direction side. The outer surface on the third negative direction side contacts an outer surface of the first insulating layer on a third positive direction side. When the inductor component is viewed in a see-through manner in the third positive direction, the protruding portion is within a range surrounded by an outer edge of the wiring body and extends along the wiring body. When viewed in a cross section orthogonal to a first main surface, a dimension of the protruding portion parallel to the first main surface is smaller than a dimension, in the direction parallel to the first main surface, of the wiring body where the protruding portion is connected.

### CROSS-REFERENCE TO RELATED APPLICATIONS

This application claims benefit of priority to International Patent Application No. PCT/JP 2024/015296, filed Apr. 17, 2024, and to Japanese Patent Application No. 2023-152732, filed Sep. 20, 2023, the entire contents of each are incorporated herein by reference.

### BACKGROUND

### Technical Field:

The present disclosure relates to an inductor component, a manufacturing method for an inductor component, and a substrate for inductor component manufacturing.
Background Art:
An inductor component disclosed in Japanese U.S. Pat. No. 6,447,368 includes an element body and an inductor wiring line. The element body has a first main surface. The inductor wiring line extends in the element body in parallel with the first main surface. Further, the inductor wiring line has a spiral shape. That is, the inductor wiring line has portions arranged in parallel.

### SUMMARY

In an inductor component such as that disclosed in Japanese U.S. Pat. No. 6,447,368, the cross-sectional area of an inductor wiring line is sometimes increased in order to reduce the direct-current resistance of the inductor wiring line. However, for example, when the width dimension of the inductor wiring line is increased, the spacing between portions arranged in parallel in the inductor wiring line becomes smaller. Thus, when a manufacturing error or the like occurs, the likelihood of a short circuit between the portions arranged in parallel in the inductor wiring line, or the like, increases.

Accordingly, an aspect of the present disclosure provides an inductor component including an element body that contains a magnetic material and has a main surface having a planar shape, an insulating layer that is located in the element body and extends on a plane parallel to the main surface, and an inductor wiring line that extends in the element body in parallel with the main surface. When one of directions orthogonal to the main surface is defined as a positive direction and a direction opposite to the positive direction is defined as a negative direction, the inductor wiring line includes a wiring body that extends on an outer surface of the insulating layer on the positive direction side and a protruding portion that protrudes toward the negative direction side from an outer surface of the wiring body on the negative direction side. The outer surface of the wiring body on the negative direction side is in contact with the outer surface of the insulating layer on the positive direction side. When the inductor component is viewed in a see-through manner in the positive direction, the protruding portion is located within a range surrounded by an outer edge of the wiring body and extends along the wiring body. When viewed in a cross section orthogonal to the main surface, a dimension of the protruding portion in a direction parallel to the main surface is smaller than a dimension, in the direction parallel to the main surface, of the wiring body at a location where the protruding portion is connected.

Further, an aspect of the present disclosure provides a manufacturing method for an inductor component. The manufacturing method includes a seed layer forming step of forming a seed layer having conductivity over a main surface of a base substrate, an insulating layer forming step of forming, on the seed layer, an insulating layer having an opening of a predetermined wiring pattern, and a resin wall forming step of forming a resin wall on the insulating layer along an outer edge of the opening. The manufacturing method also includes an inductor wiring line forming step of, by electrolytic plating performed by supplying power to the seed layer, forming a wiring body in a space surrounded by the resin wall and monolithically forming, in the opening, a protruding portion that protrudes from the wiring body and extends along the wiring body, an element body forming step of forming a magnetic layer containing a magnetic material around the inductor wiring line after the inductor wiring line forming step, and a seed layer removing step of removing the seed layer after the first element body forming step.

Further, an aspect of the present disclosure provides a substrate for inductor component manufacturing. The substrate includes a base substrate, a seed layer that is located over a main surface of the base substrate and has conductivity, an insulating layer that is located on the seed layer and is parallel to the main surface of the base substrate, and an inductor wiring line that is located on the insulating layer and extends in parallel with the main surface of the base substrate. When one of directions orthogonal to the main surface of the base substrate is defined as a positive direction and a direction opposite to the positive direction is defined as a negative direction, the inductor wiring line includes a wiring body that extends on an outer surface of the insulating layer on the positive direction side and a protruding portion that protrudes toward the negative direction side from an outer surface of the wiring body on the negative direction side. When viewed in the positive direction, the protruding portion extends along the wiring body. A surface of the protruding portion on the negative direction side is in contact with the seed layer.

It is possible to reduce the direct-current resistance of the inductor wiring line while preventing a short circuit between different portions of the inductor wiring line.

### BRIEF DESCRIPTION OF THE DRAWINGS

FIG. 1 is a perspective view of an inductor component of a first embodiment;

FIG. 2 is a diagram depicting, in a see-through manner, the inductor component of the first embodiment from a side surface;

FIG. 3 is a cross-sectional view taken along line 3-3 in FIG. 2;

FIG. 4 is a cross-sectional view taken along line 4-4 in FIG. 3;

FIG. 5 is a flowchart of manufacturing steps for the inductor component of the first embodiment;

FIG. 6 is an explanatory diagram of a manufacturing method for the inductor component of the first embodiment;

FIG. 7 is an explanatory diagram of the manufacturing method for the inductor component of the first embodiment;

FIG. 8 is an explanatory diagram of the manufacturing method for the inductor component of the first embodiment;

FIG. 9 is an explanatory diagram of the manufacturing method for the inductor component of the first embodiment;

FIG. 10 is an explanatory diagram of the manufacturing method for the inductor component of the first embodiment;

FIG. 11 is an explanatory diagram of the manufacturing method for the inductor component of the first embodiment;

FIG. 12 is an explanatory diagram of the manufacturing method for the inductor component of the first embodiment;

FIG. 13 is an explanatory diagram of the manufacturing method for the inductor component of the first embodiment;

FIG. 14 is an explanatory diagram of the manufacturing method for the inductor component of the first embodiment;

FIG. 15 is an explanatory diagram of the manufacturing method for the inductor component of the first embodiment;

FIG. 16 is an explanatory diagram of the manufacturing method for the inductor component of the first embodiment;

FIG. 17 is an explanatory diagram of the manufacturing method for the inductor component of the first embodiment;

FIG. 18 is an explanatory diagram of the manufacturing method for the inductor component of the first embodiment;

FIG. 19 is an explanatory diagram of the manufacturing method for the inductor component of the first embodiment;

FIG. 20 is an explanatory diagram of the manufacturing method for the inductor component of the first embodiment;

FIG. 21 is a perspective view of an inductor component of a second embodiment;

FIG. 22 is a diagram depicting, in a see-through manner, the inductor component of the second embodiment from an upper surface;

FIG. 23 is a cross-sectional view taken along line 23-23 in FIG. 22;

FIG. 24 is a flowchart of manufacturing steps for the inductor component of the second embodiment;

FIG. 25 is an explanatory diagram of a manufacturing method for the inductor component of the second embodiment;

FIG. 26 is an explanatory diagram of the manufacturing method for the inductor component of the second embodiment;

FIG. 27 is an explanatory diagram of the manufacturing method for the inductor component of the second embodiment;

FIG. 28 is an explanatory diagram of the manufacturing method for the inductor component of the second embodiment;

FIG. 29 is an explanatory diagram of the manufacturing method for the inductor component of the second embodiment;

FIG. 30 is an explanatory diagram of the manufacturing method for the inductor component of the second embodiment;

FIG. 31 is a perspective view of an inductor component of a modification;

FIG. 32 is a diagram depicting the inductor component of the modification in a see-through manner;

FIG. 33 is a cross-sectional view of an inductor component of a modification;

FIG. 34 is a cross-sectional view of an inductor component of a modification; and

FIG. 35 is an explanatory diagram of a manufacturing method for an inductor component of a modification.

### DETAILED DESCRIPTION

Embodiments of an inductor component are described below with reference to the drawings. In the drawings, a component is sometimes depicted in an enlarged manner for ease of understanding. A dimensional ratio of a component is sometimes different from actual one or from that indicated in another drawing.

### INDUCTOR COMPONENT OF FIRST EMBODIMENT

A first embodiment of an inductor component and a manufacturing method for an inductor component is described below.

### Overall Configuration

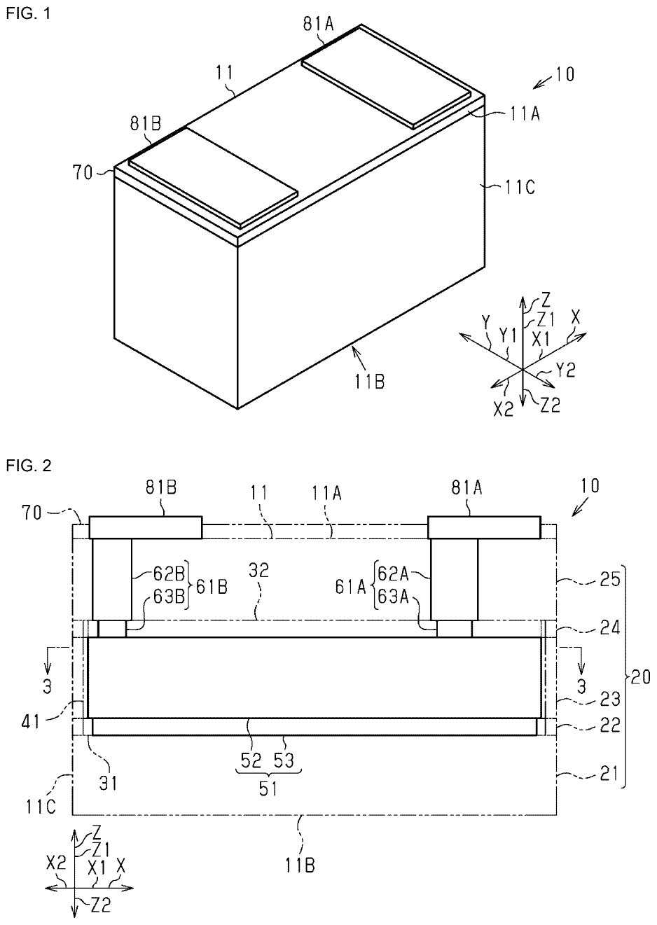

As depicted in FIG. 1, an inductor component 10 has a substantially rectangular parallelepiped shape as a whole. The inductor component 10 includes an element body 11.

The element body 11 has a substantially rectangular parallelepiped shape. That is, the element body 11 has six planar outer surfaces. Among these six outer surfaces, one specific surface is defined as a first main surface 11A. Further, the surface that is located on the side opposite to the first main surface 11A and is parallel to the first main surface 11A is defined as a second main surface 11B. In addition, the four surfaces perpendicular to the first main surface 11A, in other words, the outer surfaces excluding the first main surface 11A and the second main surface 11B, are defined as side surfaces 11C of the element body 11. The outer shape of the first main surface 11A, the outer shape of the second main surface 11B, and the outer shapes of the side surfaces 11C of the element body 11 are all rectangular.

Here, an axis parallel to a long side of the first main surface 11A is defined as a first axis X. An axis parallel to a short side of the first main surface 11A is defined as a second axis Y. An axis perpendicular to the first main surface 11A is defined as a third axis Z. In the present embodiment, the first axis X, the second axis Y, and the third axis Z are orthogonal to each other. Further, of directions along the first axis X, one specific direction is defined as a first positive direction X1, and the direction opposite to the first positive direction X1 is defined as a first negative direction X2. Further, of directions along the second axis Y, one specific direction is defined as a second positive direction Y1, and the direction opposite to the second positive direction Y1 is defined as a second negative direction Y2. In addition, of directions along the third axis Z, the direction in which the first main surface 11A faces is defined as a third positive direction Z1, and the direction opposite to the third positive direction Z1 is defined as a third negative direction Z2.

As depicted in FIG. 2, the element body 11 has, as magnetic layers 20, a first magnetic layer 21, a first interlayer magnetic layer 22, a second magnetic layer 23, a second interlayer magnetic layer 24, and a third magnetic layer 25 in that order from the third negative direction Z2 side. That is, among outer surfaces of the third magnetic layer 25, the outer surface facing in the third positive direction Z1 is the first main surface 11A. Among outer surfaces of the first magnetic layer 21, the outer surface facing in the third negative direction Z2 is the second main surface 11B. In FIG. 2, boundaries of the respective magnetic layers 20 are virtually depicted by dash-dot-dot lines. In practice, clear boundaries are not observable between these respective magnetic layers 20 in some cases.

The material of the magnetic layers 20, that is, the material of the element body 11, contains a magnetic material. Specifically, the material of the element body 11 is an organic resin containing metal magnetic powder. In the present embodiment, the metal magnetic powder is metal magnetic powder composed of an Fe-based alloy or an amorphous alloy. Specifically, the metal magnetic powder is FeSiCr-based metal powder containing iron.

The inductor component 10 includes two insulating layers. The two insulating layers are a first insulating layer 31 and a second insulating layer 32.

The first insulating layer 31 extends on a plane parallel to the first main surface 11A in the element body 11. The first insulating layer 31 is in contact with the surface of the first magnetic layer 21 on the third positive direction Z1 side. In the third axis Z direction, the position of the first insulating layer 31 is the same as that of the first interlayer magnetic layer 22.

The second insulating layer 32 extends on a plane parallel to the first main surface 11A in the element body 11. The second insulating layer 32 is in contact with the surface of the third magnetic layer 25 on the third negative direction Z2 side. In the third axis Z direction, the position of the second insulating layer 32 is the same as that of the second interlayer magnetic layer 24. The term “parallel” includes a substantially parallel state and allows for manufacturing errors. For example, when an acute angle formed between the first insulating layer 31 and the first main surface 11A is less than 5 degrees, they are regarded as being parallel.

As depicted in FIG. 2, the inductor component 10 includes an inductor wiring line 51. The material of the inductor wiring line 51 is a conductive material. In the present embodiment, the composition of the inductor wiring line 51 has a copper content of 99 wt % or more and a sulfur content of 0.1 wt % or more and 1.0 wt % or less (i.e., from 0.1 wt % to 1.0 wt %).

The inductor wiring line 51 is located inside the element body 11. The inductor wiring line 51 extends in parallel with the first main surface 11A. The inductor wiring line 51 is located in the same layers as the first insulating layer 31 and the second magnetic layer 23 in the third axis Z direction. That is, an outer surface of the inductor wiring line 51 on the third negative direction Z2 side is in contact with the outer surface of the first magnetic layer 21 on the third positive direction Z1 side. The second insulating layer 32 is located on an outer surface of the inductor wiring line 51 on the third positive direction Z1 side.

The inductor wiring line 51 includes a wiring body 52. The wiring body 52 is a portion of the inductor wiring line 51 that is located in the same layer as the second magnetic layer 23 in the third axis Z direction. Accordingly, the wiring body 52 extends on an outer surface of the first insulating layer 31 on the third positive direction Z1 side. That is, an outer surface of the wiring body 52 on the third negative direction Z2 side is in contact with the outer surface of the first insulating layer 31 on the third positive direction Z1 side.

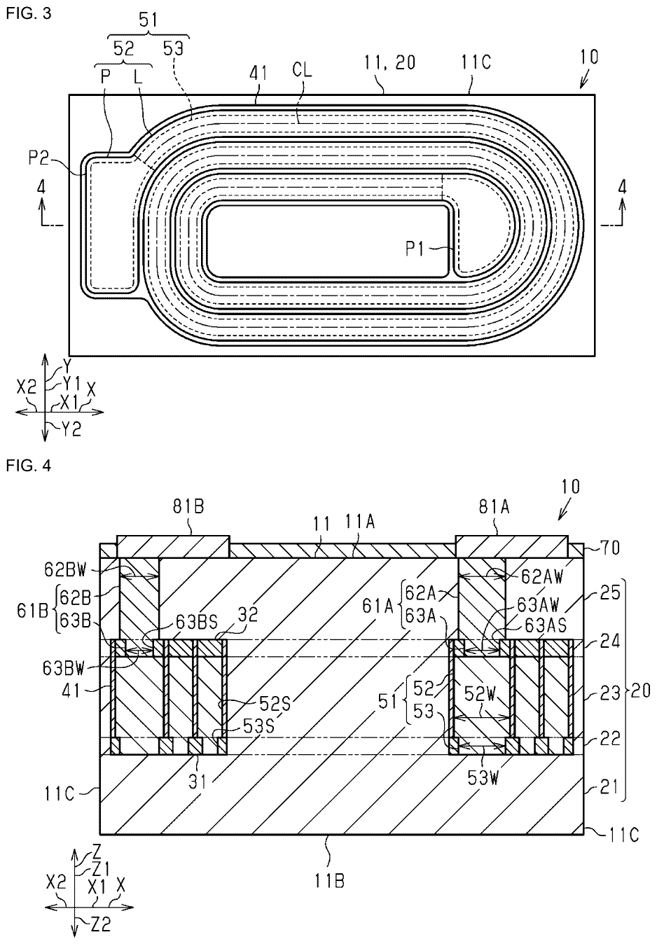

As depicted in FIG. 3, when the inductor component 10 is viewed in a see-through manner in the third negative direction Z2, the inductor wiring line 51 extends in a spiral shape. Further, there is a distance between an outer edge of the inductor wiring line 51 and the side surfaces 11C of the element body 11. Accordingly, the inductor wiring line 51 is not exposed at the side surfaces 11C of the element body 11. Further, in this embodiment, no other conductive object extending to the side surface 11C of the element body 11 is connected to the inductor wiring line 51. Therefore, at the side surfaces 11C of the element body 11, no conductive object electrically connected to the inductor wiring line 51 is exposed.

The wiring body 52 has a pair of pad portions P and a wiring portion L. The pad portions P are located at both end portions of the wiring body 52. Of the pair of pad portions P, the pad portion P located on the first positive direction X1 side is defined as an inner pad portion P1. The pad portion P located on the first negative direction X2 side is defined as an outer pad portion P2. In other words, when the inductor component 10 is viewed in a see-through manner in the third negative direction Z2, the inner pad portion P1 is located on the first positive direction X1 side relative to the geometric center of the element body 11. The outer pad portion P2 is located on the first negative direction X2 side relative to the inner pad portion P1.

The wiring portion L connects the pair of pad portions P. Specifically, when the inductor component 10 is viewed in a see-through manner in the third negative direction Z2, the wiring portion L extends counterclockwise from the inner pad portion P1 toward the outer pad portion P2 such that the diameter increases as the number of turns increases. The number of turns of the wiring portion L is approximately 2.0 turns.

The number of turns of the wiring portion L is defined as follows on the basis of a virtual vector. First, a vector having an initial point and a terminal point at a first end of a center line CL of the wiring portion L is assumed. In this state, the vector is a zero vector. Then, in a state in which the vector is viewed in the third negative direction Z2, while the initial point of the vector is fixed, the terminal point of the vector is moved along the center line CL of the wiring portion L to a second end of the center line CL. At this time, the number of turns is calculated such that a rotation of the direction of the vector by 360 degrees is regarded as 1.0 turn. For example, when the virtual vector rotates by 180 degrees, the number of turns is 0.5 turns.

In the wiring portion L, the width dimension in the direction perpendicular to the center line CL and parallel to the first main surface 11A is substantially constant over the entirety of the wiring portion L. The center line CL of the wiring portion L is defined as follows. When the inductor component 10 is viewed in a see-through manner in the third negative direction Z2, among line segments connecting any point on an outer edge of the wiring portion L and a point on the outer edge opposite thereto, a line segment having the shortest distance between the two points is identified. When the line segments are identified over the entire region of the outer edge of the wiring portion L in this manner, a line connecting midpoints of the identified line segments is defined as the center line CL of the wiring portion L when the inductor component 10 is viewed in a see-through manner in the third negative direction Z2.

As depicted in FIG. 4, the inductor component 10 includes a resin wall 41. The material of the resin wall 41 is an insulating resin. The resin wall 41 is stacked on part of the surface of the first insulating layer 31 on the third positive direction Z1 side. The resin wall 41 is located in the same layer as the wiring body 52 and the second magnetic layer 23 in the third axis Z direction. The resin wall 41 covers a side surface 52S of the wiring body 52 among outer surfaces of the inductor wiring line 51. Further, the resin wall 41 also extends in the same layer as the second interlayer magnetic layer 24 and the second insulating layer 32 in the third axis Z direction. That is, the resin wall 41 is also in contact with the second interlayer magnetic layer 24 and the second insulating layer 32. The side surface 52S of the wiring body 52 is, among outer surfaces of the wiring body 52, an outer surface excluding an outer surface on the third positive direction Z1 side and the outer surface on the third negative direction Z2 side.

In FIG. 4, an outer surface of the resin wall 41 on the third positive direction Z1 side is depicted so as to be in contact with the outer surface of the third magnetic layer 25 on the third negative direction Z2 side. In practice, the outer surface of the resin wall 41 on the third positive direction Z1 side may be embedded in the second insulating layer 32 without being in contact with the outer surface of the third magnetic layer 25 on the third negative direction Z2 side.

The inductor component 10 includes a first columnar wiring line 61A and a second columnar wiring line 61B. The material of each columnar wiring line is the same as that of the inductor wiring line 51. Each columnar wiring line extends in a direction intersecting the first main surface 11A. Each columnar wiring line is located in the same layers as the second interlayer magnetic layer 24 and the third magnetic layer 25 in the third axis Z direction. Each columnar wiring line extends in the direction orthogonal to the first main surface 11A, that is, in the third axis Z direction.

Each columnar wiring line is in contact with the outer surface of the wiring body 52 on the third positive direction Z1 side. Thus, each columnar wiring line is electrically connected to the inductor wiring line 51. Specifically, an outer surface of the first columnar wiring line 61A on the third negative direction Z2 side is in contact with a surface of the inner pad portion P1 that is parallel to the first main surface 11A. An outer surface of the second columnar wiring line 61B on the third negative direction Z2 side is in contact with a surface of the outer pad portion P2 that is parallel to the first main surface 11A.

The inductor component 10 includes a first outer electrode 81A and a second outer electrode 81B. Each outer electrode is located on the first main surface 11A of the element body 11. That is, each outer electrode covers part of the outer surface of the element body 11.

The first outer electrode 81A is located, on the first main surface 11A, on the first positive direction X1 side relative to the geometric center of the first main surface 11A. The second outer electrode 81B is located, on the first main surface 11A, on the first negative direction X2 side relative to the geometric center of the first main surface 11A. Further, the first outer electrode 81A is in contact with a surface of the first columnar wiring line 61A that faces in the third positive direction Z1. The second outer electrode 81B is in contact with a surface of the second columnar wiring line 61B that faces in the third positive direction Z1.

The inductor component 10 includes a solder resist 70. The solder resist 70 has higher insulating properties than the element body 11. The solder resist 70 covers a portion excluding at least the two outer electrodes in the surface of the element body 11 that faces in the third positive direction Z1. That is, the first main surface 11A of the element body 11 is not exposed because it is covered with the outer electrodes and the solder resist 70. It is not required that the entirety of an outer surface of the solder resist 70 on the third positive direction Z1 side be exposed. For example, part of each outer electrode may cover part of the outer surface of the solder resist 70 on the third positive direction Z1 side.

### Protruding Portion

Next, a detailed configuration of the inductor wiring line 51 is described.

As depicted in FIG. 4, the inductor wiring line 51 includes a protruding portion 53 in addition to the wiring body 52. The inductor wiring line 51 is formed in a single step by an electrolytic plating method in a manufacturing method described later. That is, the wiring body 52 and the protruding portion 53 are monolithically-formed objects.

The protruding portion 53 is a portion of the inductor wiring line 51 that is located in the same layer as the first interlayer magnetic layer 22 in the third axis Z direction. The protruding portion 53 protrudes toward the third negative direction Z2 side from the outer surface of the wiring body 52 on the third negative direction Z2 side. Specifically, the protruding portion 53 protrudes from both the wiring portion L and the pad portions P. Further, the protruding portion 53 penetrates the first insulating layer 31. In the present embodiment, in the third axis Z direction, the dimension of the protruding portion 53 is the same as that of the first insulating layer 31. Accordingly, in the third axis Z direction, the position of the protruding portion 53, the position of the first insulating layer 31, and the position of the first interlayer magnetic layer 22 are the same.

Further, an outer surface of the protruding portion 53 on the third negative direction Z2 side is in contact with the element body 11. A side surface 53S of the protruding portion 53 is in contact with the first insulating layer 31. The side surface 53S of the protruding portion 53 is an outer surface excluding the outer surface on the third negative direction Z2 side among outer surfaces of the protruding portion 53. However, because the protruding portion 53 protrudes from the wiring body 52, the protruding portion 53 does not have an outer surface on the third positive direction Z1 side.

When the inductor component 10 is viewed in a see-through manner in the third positive direction Z1, the protruding portion 53 extends along the wiring body 52. Specifically, the protruding portion 53 extends from the inner pad portion P1 through the wiring portion L to the outer pad portion P2. That is, the protruding portion 53 extends over substantially the entire region of the wiring body 52. Further, as depicted in FIG. 3, when the inductor component 10 is viewed in a see-through manner in the third positive direction Z1, the protruding portion 53 is located within a range surrounded by an outer edge of the wiring body 52. More specifically, as depicted in FIG. 4, when viewed in a cross section orthogonal to the first main surface 11A, a dimension in the direction parallel to the first main surface 11A at each portion of the inductor wiring line 51 is defined as a width dimension. A width dimension 53W of the protruding portion 53 is smaller than a width dimension 52W of the wiring body 52 at a location where the protruding portion 53 is connected on the same cross section.

### Extended Portion

Next, a detailed configuration of each columnar wiring line is described.

As depicted in FIG. 4, the first columnar wiring line 61A includes a first columnar portion 62A and a first extended portion 63A. The first columnar wiring line 61A is formed in one time of a step by an electrolytic plating method in the manufacturing method described later. Thus, the first columnar portion 62A and the first extended portion 63A are monolithically-formed objects. A shape of the first columnar portion 62A and a shape of the first extended portion 63A are both substantially semicircular column shapes corresponding to a shape of the inner pad portion P1.

The first columnar portion 62A is a portion of the first columnar wiring line 61A that is located in the same layer as the third magnetic layer 25 in the third axis Z direction. The first columnar portion 62A extends toward the third positive direction Z1 side from an outer surface of the second insulating layer 32 on the third positive direction Z1 side. That is, an outer surface of the first columnar portion 62A on the third negative direction Z2 side is in contact with the outer surface of the second insulating layer 32 on the third positive direction Z1 side.

The first extended portion 63A is a portion located in the same layer as the second interlayer magnetic layer 24 in the third axis Z direction. The first extended portion 63A protrudes toward the third negative direction Z2 side from the outer surface of the first columnar portion 62A on the third negative direction Z2 side. Further, the first extended portion 63A penetrates the second insulating layer 32. Further, in the third axis Z direction, the dimension of the first extended portion 63A is the same as that of the second insulating layer 32. Accordingly, in the third axis Z direction, the position of the first extended portion 63A, the position of the second insulating layer 32, and the position of the second interlayer magnetic layer 24 are the same.

An outer surface of the first extended portion 63A on the third negative direction Z2 side, which is one end thereof, is in contact with the surface of the inner pad portion P1 that is parallel to the first main surface 11A. An outer edge of the first extended portion 63A is parallel to an outer edge of the inner pad portion P1. Further, when the inductor component 10 is viewed in a see-through manner in the third positive direction Z1, the outer edge of the first extended portion 63A is parallel to an outer edge of the first columnar portion 62A. In addition, when the inductor component 10 is viewed in a see-through manner in the third positive direction Z1, the area of a region surrounded by the outer edge of the first columnar portion 62A is less than or equal to 1.3 times the area of a region surrounded by the outer edge of the first extended portion 63A.

A side surface 63AS of the first extended portion 63A is in contact with the second insulating layer 32. The side surface 63AS of the first extended portion 63A is an outer surface excluding the outer surface on the third negative direction Z2 side among outer surfaces of the first extended portion 63A. However, because the first extended portion 63A protrudes from the first columnar portion 62A, the first extended portion 63A does not have an outer surface on the third positive direction Z1 side.

Further, when viewed in a cross section orthogonal to the first main surface 11A, a dimension in the direction parallel to the first main surface 11A at each portion of the first columnar wiring line 61A is defined as the width dimension of the first columnar wiring line 61A. A width dimension 63AW of the first extended portion 63A is smaller than a width dimension 62AW of the first columnar portion 62A at a location where the first extended portion 63A is connected on the same cross section.

The second columnar wiring line 61B has a second columnar portion 62B and a second extended portion 63B. The second columnar wiring line 61B is formed in one time of a step by an electrolytic plating method in the manufacturing method described later. Thus, the second columnar portion 62B and the second extended portion 63B are monolithically-formed objects. A shape of the second columnar portion 62B and a shape of the second extended portion 63B are both substantially quadrangular prism shapes corresponding to a shape of the outer pad portion P2.

The second columnar portion 62B is located in the same layer as the third magnetic layer 25 in the third axis Z direction. The second columnar portion 62B extends toward the third positive direction Z1 side from the outer surface of the second insulating layer 32 on the third positive direction Z1 side. That is, an outer surface of the second columnar portion 62B on the third negative direction Z2 side is in contact with the outer surface of the second insulating layer 32 on the third positive direction Z1 side.

The second extended portion 63B is a portion of the second columnar wiring line 61B that is located in the same layer as the second interlayer magnetic layer 24 in the third axis Z direction. The second extended portion 63B protrudes toward the third negative direction Z2 side from the outer surface of the second columnar portion 62B on the third negative direction Z2 side. Further, the second extended portion 63B penetrates the second insulating layer 32. Further, in the third axis Z direction, the dimension of the second extended portion 63B is the same as that of the second insulating layer 32. Accordingly, in the third axis Z direction, the position of the second extended portion 63B, the position of the second insulating layer 32, the position of the second interlayer magnetic layer 24, and the position of the first extended portion 63A are the same.

An outer surface of the second extended portion 63B on the third negative direction Z2 side, which is one end thereof, is in contact with the surface of the outer pad portion P2 that is parallel to the first main surface 11A. An outer edge of the second extended portion 63B is parallel to an outer edge of the outer pad portion P2. Further, when the inductor component 10 is viewed in a see-through manner in the third positive direction Z1, the outer edge of the second extended portion 63B is parallel to an outer edge of the second columnar portion 62B. In addition, when the inductor component 10 is viewed in a see-through manner in the third positive direction Z1, the area of a region surrounded by the outer edge of the second columnar portion 62B is less than or equal to 1.3 times the area of a region surrounded by the outer edge of the second extended portion 63B.

A side surface 63BS of the second extended portion 63B is in contact with the second insulating layer 32. The side surface 63BS of the second extended portion 63B is an outer surface excluding the outer surface on the third negative direction Z2 side among outer surfaces of the second extended portion 63B. However, because the second extended portion 63B protrudes from the second columnar portion 62B, the second extended portion 63B does not have an outer surface on the third positive direction Z1 side.

Further, when viewed in a cross section orthogonal to the first main surface 11A, a dimension in the direction parallel to the first main surface 11A at each portion of the second columnar wiring line 61B is defined as the width dimension of the second columnar wiring line 61B. A width dimension 63BW of the second extended portion 63B is smaller than a width dimension 62BW of the second columnar portion 62B at a location where the second extended portion 63B is connected on the same cross section.

### Manufacturing Method

Next, the manufacturing method for the inductor component 10 in the first embodiment is described. A so-called semi-additive process (SAP) is applied to the manufacturing method for the inductor component 10.

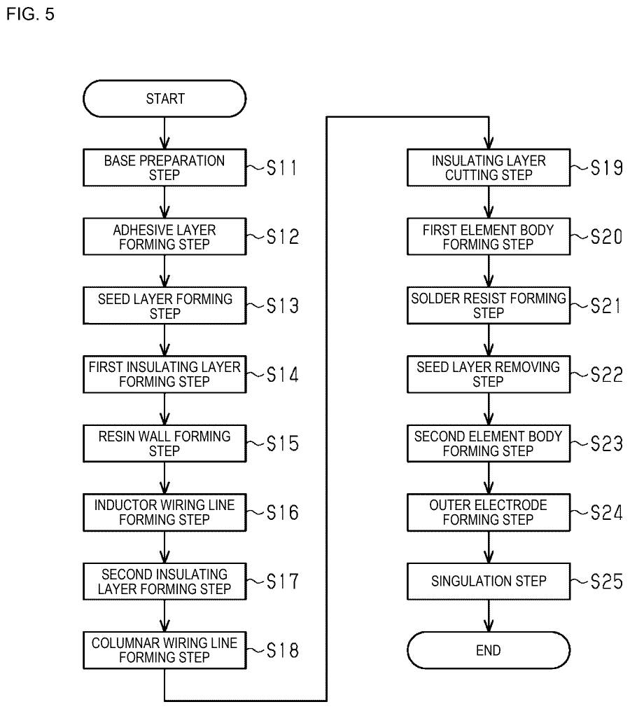

As depicted in FIG. 5, the manufacturing method for the inductor component 10 includes a base preparation step S11, an adhesive layer forming step S12, and a seed layer forming step S13. Further, the manufacturing method for the inductor component 10 includes a first insulating layer forming step S14, a resin wall forming step S15, an inductor wiring line forming step S16, a second insulating layer forming step S17, and a columnar wiring line forming step S18. Further, the manufacturing method for the inductor component 10 includes an insulating layer cutting step S19, a first element body forming step S20, a solder resist forming step S21, a seed layer removing step S22, a second element body forming step S23, an outer electrode forming step S24, and a singulation step S25.

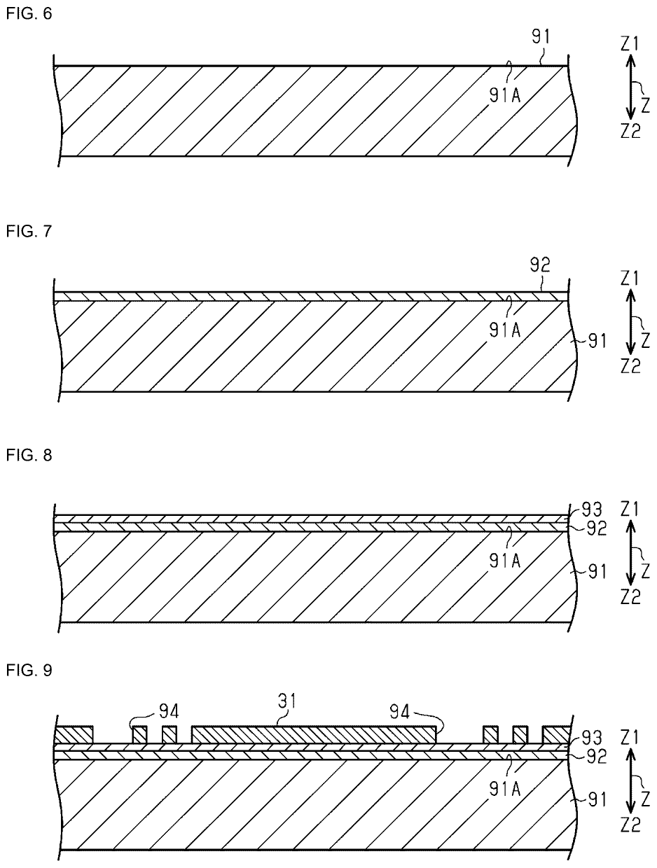

As depicted in FIG. 6, first, the base preparation step S11 is executed. Specifically, a plate-shaped base substrate 91 is prepared. The material of the base substrate 91 is a ceramic. Dimensions of a main surface 91A of the base substrate 91 are such that a plurality of inductor components 10 can be formed.

Here, an axis orthogonal to the main surface 91A of the base substrate 91 is defined as a third axis Z. In addition, of directions along the third axis Z, a direction in which the first main surface 11A faces is defined as a third positive direction Z1, and a direction opposite to the third positive direction Z1 is defined as a third negative direction Z2. In other words, the third positive direction Z1 is an “upward direction,” and the third negative direction Z2 is a “downward direction.” That is, an “upper surface” is a surface facing in the third positive direction Z1. A “lower surface” is a surface facing in the third negative direction Z2. The third positive direction Z1 during manufacturing of the inductor component 10 corresponds to the third positive direction Z1 in the inductor component 10 after manufacturing. This point is similarly applicable to the third negative direction Z2.

Next, as depicted in FIG. 7, the adhesive layer forming step S12 is executed. In the adhesive layer forming step S12, an adhesive layer 92 having adhesiveness is applied onto the main surface 91A of the base substrate 91. Specifically, the material of the adhesive layer 92 is a resin such as polyimide.

Next, as depicted in FIG. 8, the seed layer forming step S13 is executed. In the seed layer forming step S13, a seed layer 93 having conductivity is formed over the main surface 91A of the base substrate 91. Specifically, the seed layer 93 is formed on an upper surface of the adhesive layer 92 by sputtering. Further, the material of the seed layer 93 is copper. The seed layer 93 formed in the seed layer forming step S13 of this embodiment is not a layer for which so-called patterning has been performed. For example, the seed layer 93 is formed over the entire main surface 91A of the base substrate 91.

Next, as depicted in FIG. 9, the first insulating layer forming step S14 is executed. In the first insulating layer forming step S14, the first insulating layer 31 having a first opening 94 of a predetermined wiring pattern is formed on an upper surface of the seed layer 93 by a photolithography method. A position and a shape of the first opening 94 correspond to a position and a shape of the protruding portion 53 of the inductor wiring line 51 to be formed in a later step. Further, because the protruding portion 53 extends along the wiring body 52, the shape of the first opening 94 also corresponds to a shape of the wiring body 52 of the inductor wiring line 51. On the other hand, a range of the first opening 94 is slightly smaller than a range in which the wiring body 52 is formed. As described above, the term “predetermined wiring pattern” refers to a position and a shape along the inductor wiring line 51 to be formed in the inductor wiring line forming step S16.

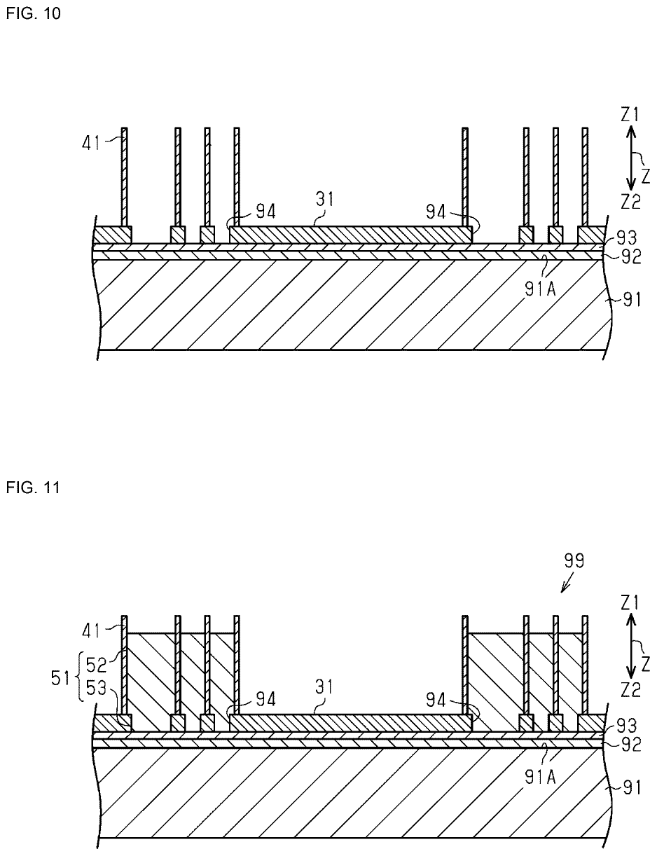

Next, as depicted in FIG. 10, the resin wall forming step S15 is executed. In the resin wall forming step S15, the resin wall 41 is formed on an upper surface of the first insulating layer 31 along an outer edge of the first opening 94 by a photolithography method. At this time, the resin wall 41 is formed at a position slightly spaced apart from an opening edge of the first opening 94.

Next, as depicted in FIG. 11, the inductor wiring line forming step S16 is executed. In the inductor wiring line forming step S16, the inductor wiring line 51 is formed by an electrolytic plating method by supplying power to the seed layer 93. More specifically, the wiring body 52 is formed in a space surrounded by the resin wall 41. In addition, in the first opening 94, the protruding portion 53 that protrudes from the wiring body 52 and extends along the wiring body 52 is monolithically formed. In the inductor wiring line forming step S16, because the inductor wiring line 51 is formed by one time of electrolytic plating, the wiring body 52 and the protruding portion 53 are monolithically formed.

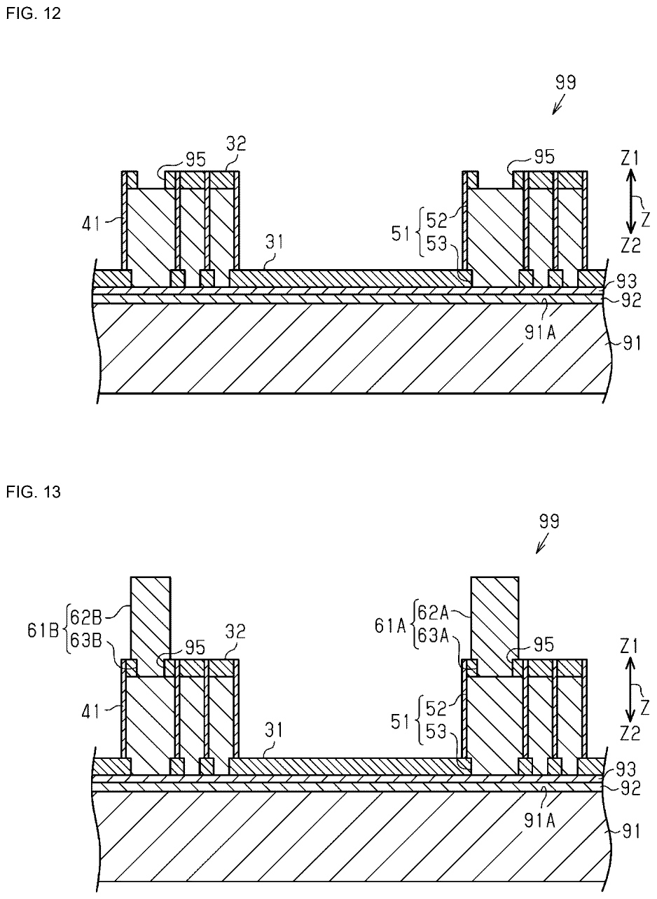

Next, as depicted in FIG. 12, the second insulating layer forming step S17 is executed. In the second insulating layer forming step S17, the second insulating layer 32 having second openings 95 of a predetermined pattern is formed on an upper surface of the wiring body 52 by a photolithography method. Positions and shapes of the second openings 95 correspond to positions and shapes of the first extended portion 63A and the second extended portion 63B to be formed later. On the other hand, a range of the second opening 95 is slightly smaller than a range in which each columnar portion is formed.

Next, as depicted in FIG. 13, the columnar wiring line forming step S18 is executed. In the columnar wiring line forming step S18, by supplying power to the seed layer 93, the respective extended portions are formed in the second openings 95 by electrolytic plating through the inductor wiring line 51, and the respective columnar portions are monolithically formed on the third positive direction Z1 side of the extended portions and the second insulating layer 32. Specifically, although depiction is omitted, support walls composed of a resin are formed on an upper surface of the second insulating layer 32 along outer edges of the second openings 95 by a photolithography method. At this time, the support wall is formed at a position slightly spaced apart from an opening edge of the second opening 95. Next, by an electrolytic plating method, the respective columnar portions are formed in spaces surrounded by the support walls. In addition thereto, in the second openings 95, the first extended portion 63A protruding from the first columnar portion 62A is monolithically formed, and the second extended portion 63B protruding from the second columnar portion 62B is monolithically formed. Subsequently, the support walls are removed to form each columnar wiring line.

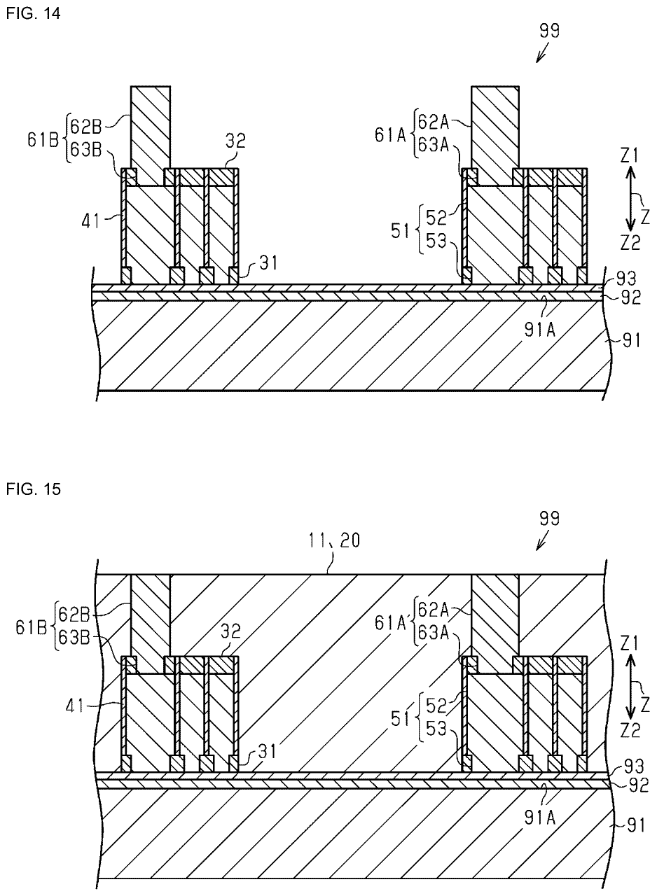

Next, as depicted in FIG. 14, the insulating layer cutting step S19 is executed. In the insulating layer cutting step S19, an unnecessary portion of the first insulating layer 31 is removed by a laser. Specifically, a portion of the first insulating layer 31 that does not overlap a region in which the inductor wiring line 51 and the resin wall 41 are present when viewed in a direction orthogonal to the main surface 91A of the base substrate 91 is cut such that the seed layer 93 is exposed.

Next, as depicted in FIG. 15, the first element body forming step S20 is executed. In the first element body forming step S20, the magnetic layers 20 containing a magnetic material are formed around the inductor wiring line 51, each extended portion, and each columnar portion. Specifically, the magnetic layers 20 other than the first magnetic layer 21 are formed around the first insulating layer 31 that covers the protruding portion 53, around the resin wall 41 that covers the wiring body 52, around the second insulating layer 32 that covers the two extended portions, and around the two columnar portions.

More specifically, in the first element body forming step S20, first, a resin containing magnetic powder is applied onto the upper surface of the seed layer 93. At this time, the resin containing magnetic powder is applied so as to also cover an upper surface of each columnar wiring line. Next, the resin containing magnetic powder is solidified by press processing. Thereafter, a portion of the resin on the upper surface side is removed until the upper surface of each columnar wiring line is exposed. As a result, on the upper surface side of the seed layer 93, the first interlayer magnetic layer 22, the second magnetic layer 23, the second interlayer magnetic layer 24, and the third magnetic layer 25 are formed. In FIGS. 15 to 20, the first interlayer magnetic layer 22, the second magnetic layer 23, the second interlayer magnetic layer 24, and the third magnetic layer 25 are depicted as the magnetic layers 20 without distinction.

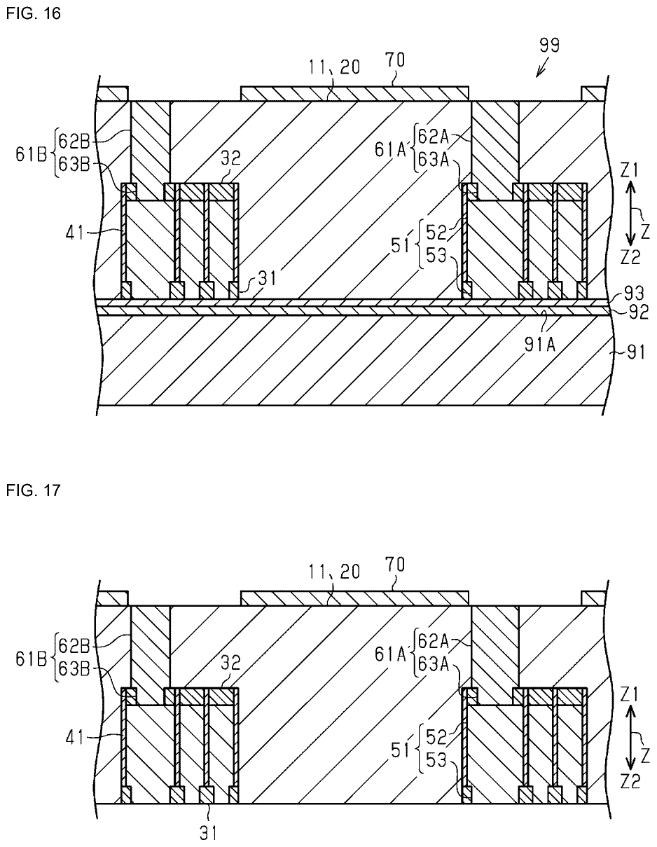

Next, as depicted in FIG. 16, the solder resist forming step S21 is executed. In the solder resist forming step S21, the solder resist 70 is formed on a region on which the first outer electrode 81A and the second outer electrode 81B are not formed in an upper surface of the third magnetic layer 25 and the upper surfaces of the respective columnar wiring lines. Specifically, an insulating resin is patterned on the region by a photolithography method. A structure in a state from the inductor wiring line forming step S16 to removal of the base substrate 91 in the seed layer removing step S22 can be treated as a substrate 99 for inductor component manufacturing.

Next, as depicted in FIG. 17, the seed layer removing step S22 is executed. In the seed layer removing step S22, first, the base substrate 91 is removed by cutting. Subsequently, the adhesive layer 92 is removed by a method such as desmear treatment or ashing. Thereafter, the seed layer 93 is removed by etching.

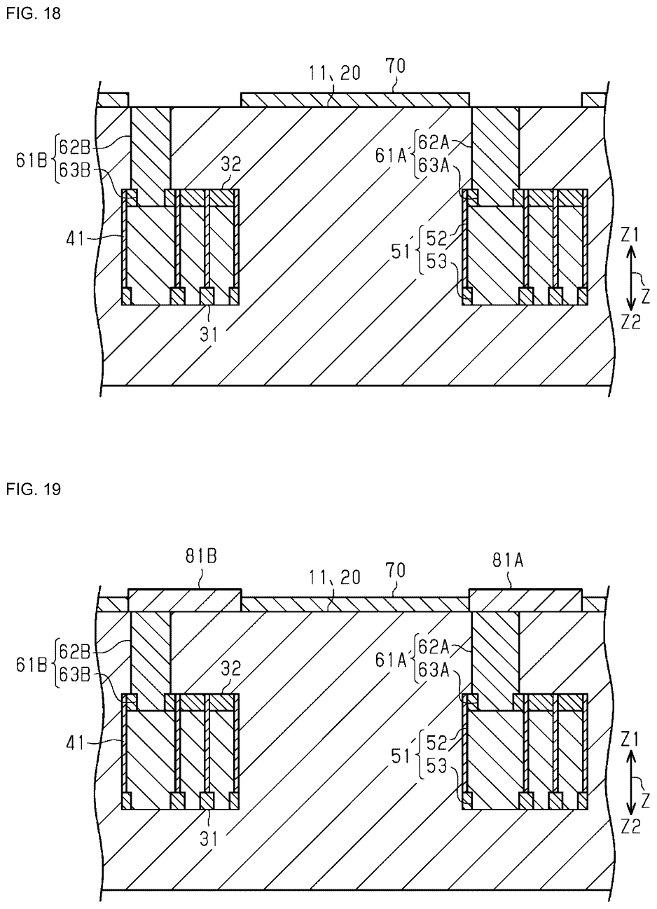

Next, as depicted in FIG. 18, the second element body forming step S23 is executed. In the second element body forming step S23, the first magnetic layer 21 containing a magnetic material is formed on lower surfaces of the first insulating layer 31 and the first interlayer magnetic layer 22. Specifically, in the second element body forming step S23, first, a resin containing magnetic powder is applied onto the lower surfaces of the first insulating layer 31 and the first interlayer magnetic layer 22. Subsequently, the resin containing magnetic powder is solidified by press processing. Thereafter, the lower surface side of the resin is removed such that dimensions of the inductor component 10 become desired values. As a result, the first magnetic layer 21 is formed on the surfaces of the first insulating layer 31 and the first interlayer magnetic layer 22 on the third negative direction Z2 side. In FIGS. 18 to 20, the first magnetic layer 21, the first interlayer magnetic layer 22, the second magnetic layer 23, the second interlayer magnetic layer 24, and the third magnetic layer 25 are depicted as the magnetic layers 20 without distinction.

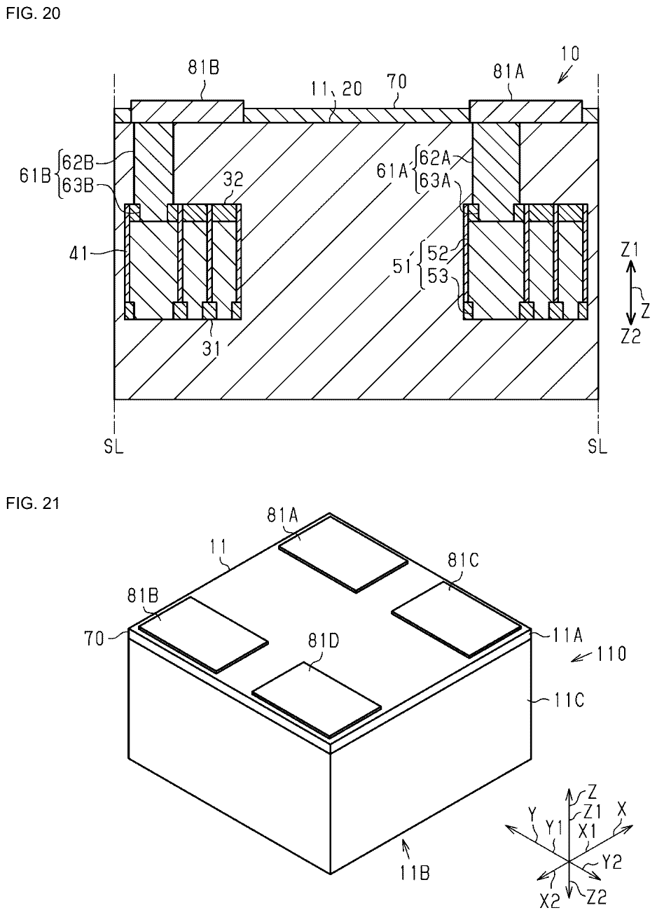

Next, as depicted in FIG. 19, the outer electrode forming step S24 is executed. In the outer electrode forming step S24, the first outer electrode 81A and the second outer electrode 81B are formed. Ranges in which the respective outer electrodes are formed are ranges that are not covered with the solder resist 70 in the upper surface of the third magnetic layer 25 and the upper surfaces of the respective columnar wiring lines. By an electroless plating method, copper plating, nickel plating, and gold plating are performed in that order on the ranges. As a result, the first outer electrode 81A and the second outer electrode 81B are formed in the above ranges. In FIGS. 19 and 20, the respective plated layers of copper, nickel, and gold are depicted without distinction.

Next, as depicted in FIG. 20, the singulation step S25 is executed. In the singulation step S25, the inductor component 10 is singulated by dicing. Specifically, a plurality of inductor components 10 integrally formed are isolated into each one individual inductor component 10. In FIG. 20, cut surfaces SL of the inductor component 10 produced by dicing are indicated by dash-dot lines. Through the above steps, the inductor component 10 is manufactured.

### Effects of First Embodiment

(1-1) In the above embodiment, the inductor wiring line 51 includes the wiring body 52 and the protruding portion 53. Further, because the protruding portion 53 protrudes from the wiring body 52, the protruding portion 53 reaches the position where the first insulating layer 31 is present in the third axis Z direction. Thus, the cross-sectional area of the inductor wiring line 51 increases by an amount corresponding to the presence of the protruding portion 53. As a result, the direct-current resistance of the inductor wiring line 51 can be reduced. In addition, the protruding portion 53 protrudes from the outer surface of the wiring body 52 on the third negative direction Z2 side, and extends along the wiring body 52. That is, the protruding portion 53 is present within the range of the outer surface of the wiring body 52 on the third negative direction Z2 side. Due to these features, the likelihood of a short circuit between different portions of the protruding portion 53 is reduced.

(1-2) In the above embodiment, the wiring body 52 and the protruding portion 53 are monolithically-formed objects. Thus, disturbance of an electric field at a boundary surface between the wiring body 52 and the protruding portion 53 can be prevented. That is, compared with a case where a clear boundary surface is present between the wiring body 52 and the protruding portion 53, the direct-current resistance can be reduced.

(1-3) In the above embodiment, neither the inductor wiring line 51 nor a conductive object is exposed at the side surfaces 11C of the element body 11. Specifically, for example, an energization wiring line for forming the inductor wiring line 51 by an electrolytic plating method is not exposed. Thus, there is no likelihood that corrosion of a conductive object exposed at the side surface 11C of the element body 11 will propagate to the inductor wiring line 51 inside the element body 11.

(1-4) In the above embodiment, the outer surface of the protruding portion 53 on the third negative direction Z2 side is in contact with the element body 11. Thus, the protruding portion 53 is not in contact with another conductive object. Due to these features, the likelihood of a short circuit between different portions of the protruding portion 53 is reduced.

(1-5) In the above embodiment, the side surface 53S of the protruding portion 53 is covered with the first insulating layer 31. Thus, insulation between different portions of the protruding portion 53 can be further enhanced.

(1-6) In the above embodiment, the inductor component 10 has the columnar wiring lines. Thus, on the first main surface 11A, the inductor wiring line 51 can be electrically connected to an external electronic board or the like.

(1-7) In the above embodiment, the inductor wiring line 51 is in contact with each columnar wiring line. Compared with a case where another metal layer is interposed between the inductor wiring line 51 and the columnar wiring line, the number of boundary surfaces in a path from the inductor wiring line 51 to the columnar wiring line is reduced. Accordingly, an increase in electrical resistance between the inductor wiring line 51 and the columnar wiring line can be prevented.

(1-8) In the above embodiment, in forming the inductor wiring line 51, a wiring pattern is formed by the first insulating layer 31. Thus, even when the inductor wiring line 51 is formed such that a distance between different portions thereof is short, the likelihood of a short circuit between these portions is low. Therefore, compared with a case where the wiring pattern is formed by a seed formed in a shape of the wiring pattern, a small space inside the element body 11 can be effectively utilized.

(1-9) In the above embodiment, the substrate 99 for inductor component manufacturing includes the base substrate 91. Thus, the base substrate 91 can be gripped and handled during a manufacturing process for the inductor component 10. For example, compared with a case where the element body 11 is directly gripped and handled, the likelihood that the inductor component 10 will be scratched can be reduced.

(1-10) In the above embodiment, the adhesive layer 92 is interposed between the base substrate 91 and the seed layer 93 during the manufacturing process for the inductor component 10. Thus, in removing the base substrate 91, separation between the seed layer 93 and the base substrate 91 is easy compared with a case where the base substrate 91 is cut or the like. Thus, the effort required for manufacturing the inductor component 10 can be reduced.

(1-11) In the above embodiment, the inductor wiring line 51 has a spiral shape, and the number of turns of the inductor wiring line 51 is greater than one turn. In other words, the inductor wiring line 51 has a part in which different portions thereof are arranged in parallel. Even in such a case, because the inductor wiring line 51 has the protruding portion 53, the cross-sectional area of the inductor wiring line 51 can be secured without increasing the width of the inductor wiring line 51. That is, it is easy to prevent a short circuit between portions arranged in parallel in the inductor wiring line 51 while securing the cross-sectional area of the inductor wiring line 51.

(1-12) In the above embodiment, each columnar wiring line includes the columnar portion and the extended portion. Further, each columnar portion is connected to the inductor wiring line 51 through the extended portion, which is an object formed monolithically with the columnar portion. That is, another conductive portion such as the seed layer 93 is not interposed between each columnar wiring line and the inductor wiring line 51. Therefore, manufacturing steps for the inductor component 10 can be simplified compared with a case where another conductive portion is present between each columnar wiring line and the inductor wiring line 51.

(1-13) In the above embodiment, when the inductor component 10 is viewed in a see-through manner in the third positive direction Z1, the outer edge of the first extended portion 63A is parallel to the outer edge of the first columnar portion 62A. Further, the outer edge of the first extended portion 63A is parallel to the outer edge of the inner pad portion P1. Thus, the structure is simplified compared with a case where the respective outer edges are not parallel to each other. This point is similarly applicable to an outer edge of the second columnar wiring line 61B and the outer edge of the outer pad portion P2.

(1-14) In the above embodiment, when the inductor component 10 is viewed in a see-through manner in the third positive direction Z1, the area of the region surrounded by the outer edge of the first columnar portion 62A is less than or equal to 1.3 times the area of the region surrounded by the outer edge of the first extended portion 63A. With such a degree of difference in area, there is a high likelihood that the columnar portion can be formed as designed by power supply through the inductor wiring line 51 without interposing a conductive portion such as the seed layer 93. This point is similarly applicable to the second columnar portion 62B and the second extended portion 63B.

(1-15) In the above embodiment, each extended portion is covered with the second insulating layer 32. Thus, insulation between each extended portion and the element body 11 can be enhanced.

(1-16) In the above embodiment, in the columnar wiring line forming step S18, each columnar portion and the extended portion are monolithically formed. That is, another conductive portion such as the seed layer 93 is not interposed between each columnar wiring line and the inductor wiring line 51 during the manufacturing process for the inductor component 10. Therefore, manufacturing steps for the inductor component 10 can be simplified compared with a case where another conductive portion is present between each columnar wiring line and the inductor wiring line 51.

### INDUCTOR COMPONENT OF SECOND EMBODIMENT

A second embodiment of an inductor component and a manufacturing method for an inductor component is described below.

### Overall Configuration of Inductor Component

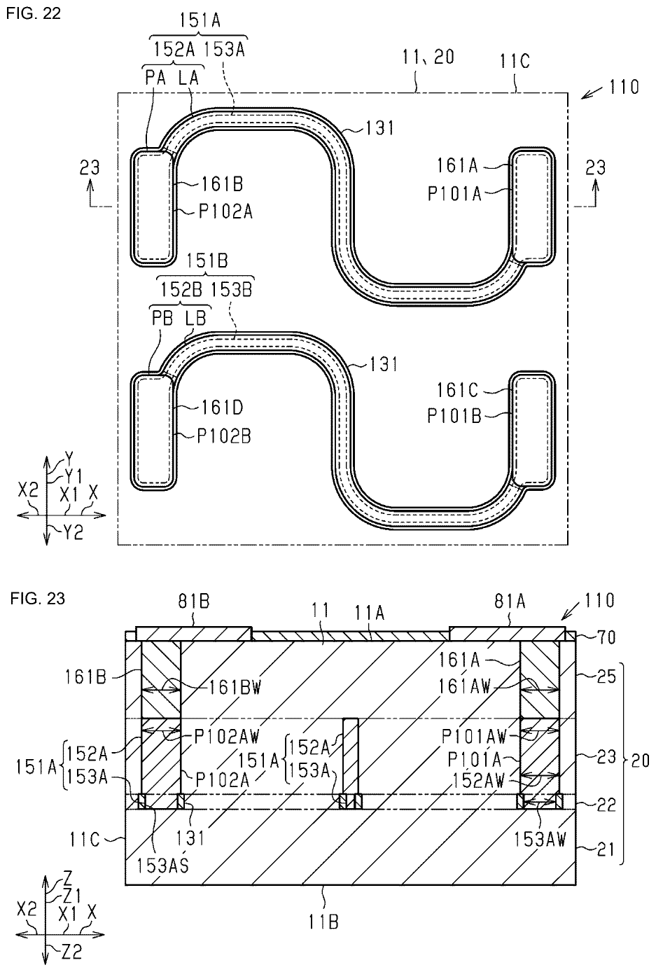

As depicted in FIGS. 21 and 22, an inductor component 110 in the second embodiment is different from the first embodiment mainly in the following points. The inductor component 110 includes a first inductor wiring line 151A and a second inductor wiring line 151B, and includes first to fourth outer electrodes 81A to 81D. Further, the element body 11 does not have the second interlayer magnetic layer 24. Further, because the element body 11 does not include the second interlayer magnetic layer 24, the inductor component 110 does not include the second insulating layer 32. In addition, each columnar wiring line does not have the extended portion. In the following description, a configuration similar to that in the first embodiment is given the same reference numeral, and description thereof is omitted or simplified.

As depicted in FIG. 21, among outer surfaces of the element body 11, the first main surface 11A and the second main surface 11B each have a substantially square outer shape.

As depicted in FIG. 22, the inductor component 110 has a first insulating layer 131. When the inductor component 110 is viewed in a see-through manner from the third positive direction Z1 side, the first insulating layer 131 extends on a plane parallel to the first main surface 11A in the element body 11. The first insulating layer 131 is in contact with a surface of the first magnetic layer 21 on the third positive direction Z1 side. In the third axis Z direction, the position of the first insulating layer 131 is the same as that of the first interlayer magnetic layer 22. In this embodiment, the first insulating layer 131 is present at two locations separately corresponding to the fact that the inductor component 110 includes the first inductor wiring line 151A and the second inductor wiring line 151B.

The inductor component 110 includes two inductor wiring lines. Specifically, the inductor component 110 includes the first inductor wiring line 151A and the second inductor wiring line 151B. The first inductor wiring line 151A and the second inductor wiring line 151B are located in the same layer in the third axis Z direction. When the inductor component 110 is viewed in a see-through manner from the third positive direction Z1 side, the first inductor wiring line 151A and the second inductor wiring line 151B extend in an S-shape.

Hereinafter, a wiring portion, two pad portions, a wiring body, and a protruding portion included in the first inductor wiring line 151A are referred to as a first wiring portion LA, first pad portions PA, a first wiring body 152A, and a first protruding portion 153A, respectively. Further, the first pad portion PA located on the first positive direction X1 side is referred to as a first end pad portion P101A, and the first pad portion PA located on the first negative direction X2 side is referred to as a second end pad portion P102A.

Further, a wiring portion, two pad portions, a wiring body, and a protruding portion included in the second inductor wiring line 151B are referred to as a second wiring portion LB, second pad portions PB, a second wiring body 152B, and a second protruding portion 153B, respectively. In addition, the second pad portion PB located on the first positive direction X1 side is referred to as a first end pad portion P101B, and the second pad portion PB located on the first negative direction X2 side is referred to as a second end pad portion P102B.

The first protruding portion 153A of the first inductor wiring line 151A has the same configuration as the protruding portion 53 of the inductor component 10 in the first embodiment. That is, as depicted in FIG. 23, an outer surface of the first protruding portion 153A on the third negative direction Z2 side is in contact with the element body 11. A side surface 153AS of the first protruding portion 153A is in contact with the first insulating layer 131. When the inductor component 110 is viewed in a see-through manner in the third positive direction Z1, the first protruding portion 153A extends along the first wiring body 152A. Specifically, the first protruding portion 153A extends from the first end pad portion P101A through the first wiring portion LA to the second end pad portion P102A. That is, the first protruding portion 153A extends over substantially the entire region of the first wiring body 152A. Further, as depicted in FIG. 22, when the inductor component 110 is viewed in a see-through manner in the third positive direction Z1, the first protruding portion 153A is located within a range surrounded by an outer edge of the first wiring body 152A. More specifically, as depicted in FIG. 23, when viewed in a cross section orthogonal to the first main surface 11A, a dimension in the direction parallel to the first main surface 11A at each portion of the first inductor wiring line 151A is defined as a width dimension. A width dimension 153AW of the first protruding portion 153A is smaller than a width dimension 152AW of the first wiring body 152A at a location where the first protruding portion 153A is connected. Further, although depiction is omitted, a configuration of the second protruding portion 153B of the second inductor wiring line 151B is the same as the configuration of the first protruding portion 153A.

As depicted in FIG. 23, an outer surface of the first inductor wiring line 151A on the third positive direction Z1 side is in contact with an outer surface of the third magnetic layer 25 on the third negative direction Z2 side. Although depiction is omitted, an outer surface of the second inductor wiring line 151B on the third positive direction Z1 side is in contact with an outer surface of the third magnetic layer 25 on the third positive direction Z1 side similarly to the first inductor wiring line 151A.

As depicted in FIG. 22, the inductor component 110 includes four columnar wiring lines. Specifically, the inductor component 110 includes a first columnar wiring line 161A, a second columnar wiring line 161B, a third columnar wiring line 161C, and a fourth columnar wiring line 161D. A shape of each columnar wiring line is a substantially rectangular columnar shape corresponding to a shape of the pad portion to which the columnar wiring line is connected.

In the present embodiment, when the inductor component 110 is viewed in a see-through manner in the third negative direction Z2, an outer edge of each columnar wiring line substantially coincides with an outer edge of the corresponding pad portion. Accordingly, the area of a region surrounded by the outer edge of each columnar wiring line is the same as the area of a region surrounded by the outer edge of the pad portion to which the columnar wiring line is connected. However, the expression “areas are the same” allows for a manufacturing error of, for example, 5%.

As depicted in FIG. 23, each columnar wiring line is located in the same layer as the third magnetic layer 25 in the third axis Z direction.

One end of the first columnar wiring line 161A is in contact with a surface of the first end pad portion P101A of the first pad portions PA that is parallel to the first main surface 11A. In this embodiment, a difference between a dimension P101AW of the first end pad portion P101A in the direction parallel to the first main surface 11A and a dimension 161AW of the first columnar wiring line 161A in the direction parallel to the first main surface 11A is substantially zero.

One end of the second columnar wiring line 161B is in contact with a surface of the second end pad portion P102A of the first pad portions PA that is parallel to the first main surface 11A. In this embodiment, a difference between a dimension P102AW of the second end pad portion P102A in the direction parallel to the first main surface 11A and a dimension 161BW of the second columnar wiring line 161B in the direction parallel to the first main surface 11A is substantially zero.

Although depiction is omitted, these points are similarly applicable to the third columnar wiring line 161C and the fourth columnar wiring line 161D. In the present embodiment, when viewed in a cross section taken along the direction orthogonal to the first main surface 11A, dimensions of each pad portion and dimensions of the columnar wiring line to which the pad portion is connected are the same in the direction parallel to the first main surface 11A. However, the expression “dimensions are the same” allows for a manufacturing error of, for example, 5%.

As depicted in FIG. 21, the inductor component 110 includes four outer electrodes. The four outer electrodes are the first outer electrode 81A, the second outer electrode 81B, the third outer electrode 81C, and the fourth outer electrode 81D.

The first outer electrode 81A is located, on the first main surface 11A, on the first positive direction X1 side and the second positive direction Y1 side relative to the geometric center of the first main surface 11A. The second outer electrode 81B is located, on the first main surface 11A, on the first negative direction X2 side and the second positive direction Y1 side relative to the above geometric center. The third outer electrode 81C is located, on the first main surface 11A, on the first positive direction X1 side and the second negative direction Y2 side relative to the above geometric center. The fourth outer electrode 81D is located, on the first main surface 11A, on the first negative direction X2 side and the second negative direction Y2 side relative to the above geometric center.

The first outer electrode 81A is in contact with a surface of the first columnar wiring line 161A that faces in the third positive direction Z1. The second outer electrode 81B is in contact with a surface of the second columnar wiring line 161B that faces in the third positive direction Z1. The third outer electrode 81C is in contact with a surface of the third columnar wiring line 161C that faces in the third positive direction Z1. The fourth outer electrode 81D is in contact with a surface of the fourth columnar wiring line 161D that faces in the third positive direction Z1.

### Manufacturing Method

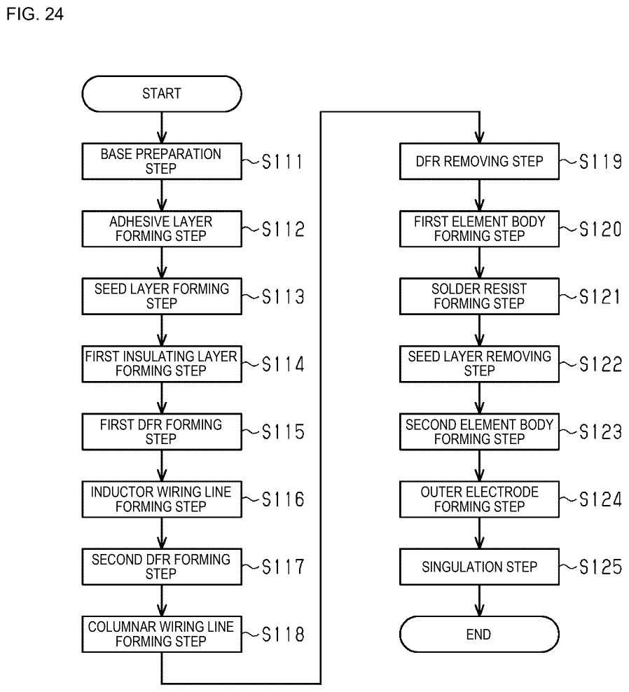

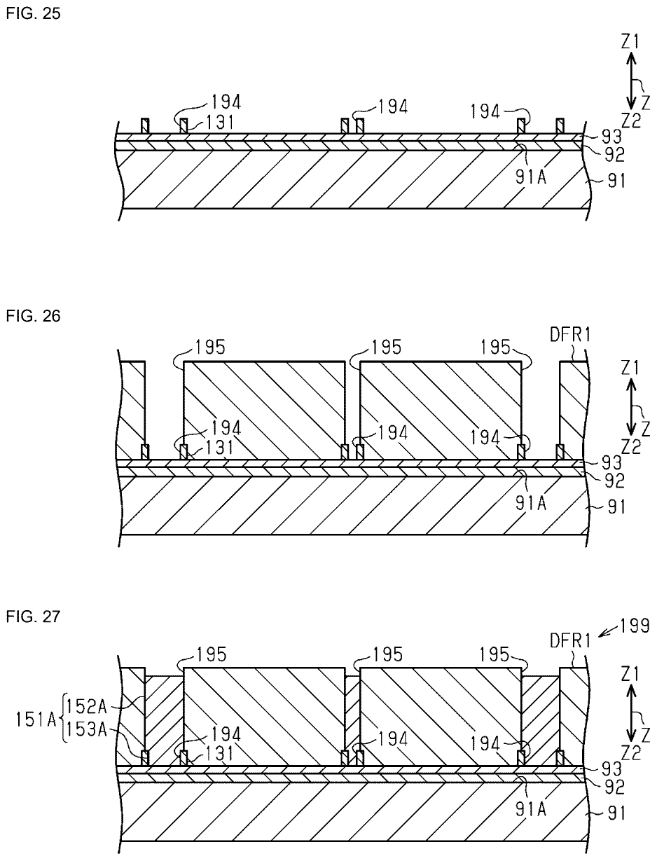

As depicted in FIG. 24, a manufacturing method for the inductor component 110 in the second embodiment is different from the manufacturing method of the first embodiment mainly in that the manufacturing method of the second embodiment does not have the resin wall forming step S15, the second insulating layer forming step S17, and the insulating layer cutting step S19. Further, the manufacturing method for the inductor component 110 in the second embodiment is different from the manufacturing method of the first embodiment mainly in that the manufacturing method of the second embodiment has a first DFR forming step S115, a second DFR forming step S117, and a DFR removing step S119. Note that, in FIGS. 25 to 30, only diagrams corresponding to the cross-sectional view of the inductor component 110 depicted in FIG. 23 are depicted. That is, in FIGS. 25 to 30, only a cross section passing through the first inductor wiring line 151A, the first columnar wiring line 161A, and the second columnar wiring line 161B is depicted. However, a cross section passing through the second inductor wiring line 151B, the third columnar wiring line 161C, and the fourth columnar wiring line 161D also includes a similar mode.

First, in the manufacturing method of the second embodiment, steps from a base preparation step S111 to a first insulating layer forming step S114 are executed by a method similar to that of the first embodiment. Specifically, as depicted in FIG. 25, in the second embodiment, after the first insulating layer forming step S114, the adhesive layer 92 has been formed on an upper surface of the base substrate 91. The seed layer 93 is formed on an upper surface of the adhesive layer 92. At this time, the seed layer 93 is formed over the entire main surface 91A of the base substrate 91. On an upper surface of the seed layer 93, the first insulating layer 131 is formed at two locations separately. Positions and shapes of first openings 194 of the first insulating layer 131 correspond to a position and a shape of the first protruding portion 153A of the first inductor wiring line 151A formed in a later step and a position and a shape of the second protruding portion 153B of the second inductor wiring line 151B formed in the later step.

Next, as depicted in FIG. 26, the first DFR forming step S115 is executed. In the first DFR forming step S115, a first dry film resist DFR1 having two second openings 195 is formed on the upper surfaces of the seed layer 93 and the first insulating layer 131 by a photolithography method. The two second openings 195 have a predetermined pattern. Specifically, a position and a shape of one of the second openings 195 correspond to a position and a shape of the first wiring body 152A to be formed later. A position and a shape of the other second opening 195 correspond to a position and a shape of the second wiring body 152B to be formed later.

Next, as depicted in FIG. 27, the inductor wiring line forming step S116 is executed. In the inductor wiring line forming step S116, each inductor wiring line is formed by an electrolytic plating method by supplying power to the seed layer 93. Specifically, the first wiring body 152A is formed in one of the second openings 195 of the first dry film resist DFR1, and the first protruding portion 153A that protrudes from the first wiring body 152A and extends along the first wiring body 152A is monolithically formed in one of the first openings 194. Further, the second wiring body 152B is formed in the other second opening 195, and the second protruding portion 153B that protrudes from the second wiring body 152B and extends along the second wiring body 152B is monolithically formed in the other first opening 194.

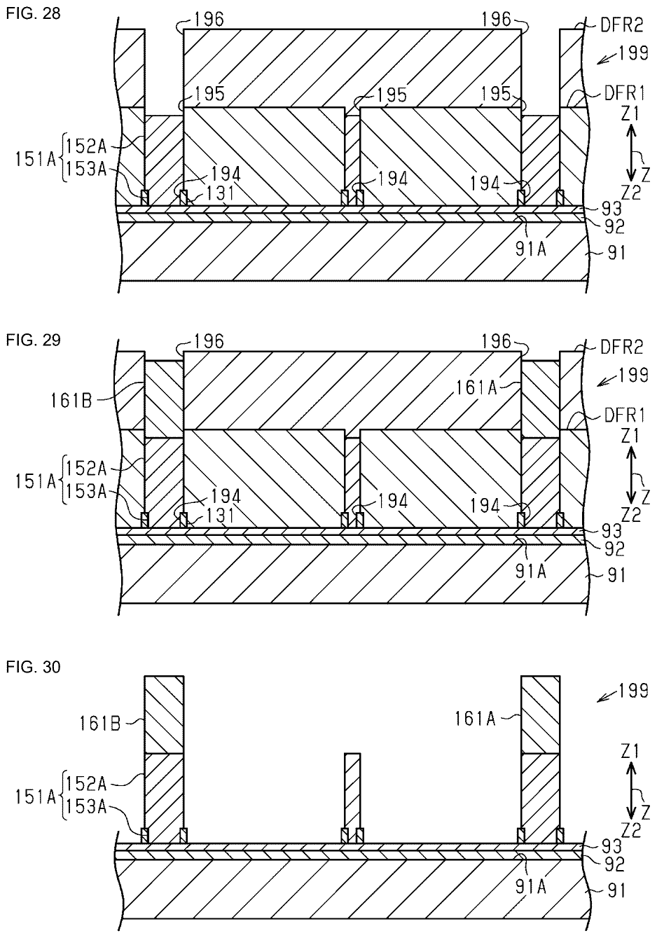

Next, as depicted in FIG. 28, the second DFR forming step S117 is executed. In the second DFR forming step S117, a second dry film resist DFR2 having four third openings 196 is formed on an upper surface of the first dry film resist DFR1 by a photolithography method.

Next, as depicted in FIG. 29, the columnar wiring line forming step S118 is executed. In the columnar wiring line forming step S118, the first to fourth columnar wiring lines 161A to 161D are formed in the four third openings 196. Positions and shapes of the first to fourth columnar wiring lines 161A to 161D correspond to positions and shapes of the four third openings 196. As a result, the first inductor wiring line 151A, the second inductor wiring line 151B, and the first to fourth columnar wiring lines 161A to 161D are formed.

Next, as depicted in FIG. 30, the DFR removing step S119 is executed. In the DFR removing step S119, the first dry film resist DFR1 and the second dry film resist DFR2 are all removed by etching.

As depicted in FIG. 24, after the DFR removing step S119 is executed, steps from a first element body forming step S120 to a singulation step S125 are executed by a method similar to that of the first embodiment. As a result, the inductor component 110 in the second embodiment is manufactured. A structure in a state from the inductor wiring line forming step S116 to removal of the base substrate 91 in the seed layer removing step S122 can be treated as a substrate 199 for inductor component manufacturing.

### Effects of Second Embodiment

According to the above second embodiment, in addition to the effects of (1-1) to (1-11) described above, the following effects are further achieved.

(2-1) In the above embodiment, the inductor component 110 includes the second inductor wiring line 151B in addition to the first inductor wiring line 151A. Thus, the mounting area can be reduced compared with a case where two inductor components each including one inductor wiring line are mounted.

(2-2) In the above embodiment, when viewed in a cross section taken along the direction orthogonal to the first main surface 11A, there is no large difference between dimensions of the respective pad portions and dimensions of the respective columnar wiring lines in the direction parallel to the first main surface 11A. Thus, compared with a case where the difference between the above dimensions is large, direct-current resistance attributed to the difference can be reduced.

### MODIFICATIONS

The above embodiments and the following modifications can be implemented in combination with each other within a range that does not cause technical inconsistency. For example, it is also possible to combine a modification of the first embodiment with the second embodiment within a range that does not cause technical inconsistency.

### Modifications of First Embodiment

The shape of the element body 11 is not limited to the example of the above embodiment. Further, the element body 11 is not required to have all of the magnetic layers 20 as long as functioning as the inductor component 10 is enabled.

The metal magnetic powder that is the material of the element body 11 is not limited to the FeSiCr-based magnetic powder. For example, FeCo-based, FeSiAr-based, or iron oxide-based metal magnetic powder may be used, or a combination of them may be used. Further, the organic resin that is the material of the element body 11 may be epoxy resin, imide resin, liquid crystal polymer resin, acrylic resin, phenol resin, and a combination of them, and an inorganic filler may be mixed in addition to these materials. Further, the material of the element body 11 may be a non-magnetic material.

The configuration of the shape, number, position, and the like of the inductor wiring line 51 is not limited to the example of the above embodiment. The configuration may be appropriately changed depending on the shape of the element body 11 and use of the inductor component 10.

The inductor wiring line 51 may be exposed at the side surface 11C of the element body 11.

The material of the inductor wiring line 51 is not limited to a conductor having copper as a main component, and may be a conductor having Ag, Al, and Au as a main component.

The protruding portion 53 is not required to continuously extend from the inner pad portion P1 to the outer pad portion P2. For example, the protruding portion 53 may have a chain-line shape intermittently extending along the inductor wiring line 51. That is, the protruding portion 53 may be partially discontinuous.

The protruding portion 53 and the wiring body 52 are not required to be monolithically-formed objects. For example, after the protruding portion 53 is formed by an electrolytic plating method, the electrolytic plating is ended. Then, the electrolytic plating is restarted to form the wiring body 52. This possibly generates an interface between the protruding portion 53 and the wiring body 52, strictly speaking. Even in this case, substantially it can be deemed that the wiring body 52 protrudes from the protruding portion 53. Further, when the protruding portion 53 and the wiring body 52 are formed as separate objects, the materials thereof are not necessarily required to be the same.

The side surface 53S of the protruding portion 53 is not required to be in contact with the first insulating layer 31. For example, another metal layer may be interposed between the protruding portion 53 and the first insulating layer 31.

In the direction orthogonal to the first main surface 11A, the dimension of the protruding portion 53 may be less than that of the first insulating layer 31. At this time, a tip of the protruding portion 53 does not protrude beyond the first insulating layer 31 toward the third negative direction Z2 side. Therefore, even if a manufacturing error or the like occurs, the tip of the protruding portion 53 is less likely to spread in a direction parallel to the first main surface 11A. As a result, it is possible to prevent the tip of the protruding portion 53 from being short-circuited with another conductive portion that is not intended.

The inductor component 10 is not required to include the columnar wiring line. For example, the inductor wiring line 51 may be connected to an outer electrode by being exposed from the side surface 11C of the element body 11.

The first extended portion 63A and the first columnar portion 62A are not required to be monolithically-formed objects. For example, after the first extended portion 63A is formed by an electrolytic plating method, the electrolytic plating is ended. Then, the electrolytic plating is restarted to form the first columnar portion 62A. This possibly generates an interface between the first extended portion 63A and the first columnar portion 62A, strictly speaking. Even in this case, substantially it can be deemed that the first columnar portion 62A protrudes from the first extended portion 63A. Further, when the first extended portion 63A and the first columnar portion 62A are formed as separate objects, the materials thereof are not necessarily required to be the same. This point is similarly applicable to the second extended portion 63B and the second columnar portion 62B.

The configuration of each extended portion is not limited to the example of the above embodiment. For example, the outer edge of the first extended portion 63A is not required to be parallel to the outer edge of the first columnar portion 62A. The first extended portion 63A is not required to be in contact with the surface parallel to the first main surface 11A among outer surfaces of the inner pad portion P1. Further, the outer edge of the first extended portion 63A is not required to be parallel to the outer edge of the inner pad portion P1. This point is similarly applicable to the second extended portion 63B and the outer pad portion P2.

When the inductor component 10 is viewed in a see-through manner in the third positive direction Z1, the area of the region surrounded by the outer edge of the first columnar portion 62A may be greater than 1.3 times the area of the region surrounded by the outer edge of the first extended portion 63A. Even in this case, because the first columnar wiring line 61A has the first extended portion 63A, at least the effect described in (1-1) can be obtained. This point is similarly applicable to the second extended portion 63B.

The side surface 63AS of the first extended portion 63A is not required to be in contact with the second insulating layer 32. For example, another member may be interposed between the first extended portion 63A and the second insulating layer 32. This point is similarly applicable to the second extended portion 63B.

The inductor component 10 is not required to include each outer electrode and the solder resist 70. For example, each columnar wiring line may be exposed from the first main surface 11A. This can reduce the size of the inductor component 10.

In the manufacturing method for the inductor component 10, the order of the respective steps may be changed as long as the inductor component 10 can be manufactured. For example, the solder resist forming step S21 may be executed after the second element body forming step S23.

The material of the seed layer 93 is not limited to the example of the above embodiment. For example, the seed layer 93 may be a single layer of copper or a single layer of silver, or may have a plurality of layers of titanium, copper, and the like.

The material of the seed layer 93 may be different from that of the protruding portion 53. For example, the material of the seed layer 93 may be silver, and the material of the inductor wiring line 51 including the protruding portion 53 may be copper. This can increase an etching rate when the inductor wiring line 51 is separated from the seed layer 93 by etching. This point is similarly applicable to the substrate 99 for inductor component manufacturing.

In steps from the adhesive layer forming step S12 to the solder resist forming step S21, the inductor wiring line 51 and the like may be formed over and under both surfaces of the base substrate 91. At this time, it is sufficient that, when the inductor wiring line 51 and the like are formed on the third negative direction Z2 side of the base substrate 91, each step be executed with the third negative direction Z2 set as the upward direction.

The adhesive layer forming step S12 may be omitted. The seed layer 93 may be formed directly on the upper surface of the base substrate 91. That is, the substrate 99 for inductor component manufacturing is not required to include the adhesive layer 92.

In the first insulating layer forming step S14, a negative photosensitive resin may be used as the material of the first insulating layer 31. At this time, by reducing the degree of photocuring of a portion to be removed in the insulating layer cutting step S19 in the first insulating layer 31, the portion may be made easier to separate in the insulating layer cutting step S19.

Depending on a configuration of the inductor component 10 to be manufactured, one or more steps selected from the second insulating layer forming step S17, the columnar wiring line forming step S18, the solder resist forming step S21, the second element body forming step S23, and the outer electrode forming step S24 may be omitted.

The second insulating layer forming step S17 may be omitted, and the columnar wiring line forming step S18 may be executed. At this time, in the columnar wiring line forming step S18, support walls may be formed on the outer surface of the inductor wiring line 51 on the third positive direction Z1 side to form each columnar wiring line.

In the insulating layer cutting step S19, the method for removing part of the first insulating layer 31 is not limited to the method based on a laser. For example, part of the first insulating layer 31 may be removed by sandblasting. At this time, it is preferable that the second insulating layer 32 be thicker than the first insulating layer 31. Alternatively, it is preferable that resistance to sandblasting in the second insulating layer 32 be higher than resistance to sandblasting in the first insulating layer 31.

In the seed layer removing step S22, the seed layer 93 may be removed by etching.

When the second element body forming step S23 is omitted, for example, a layer having insulating properties may be formed on the lower surfaces of the protruding portion 53, the first insulating layer 31, and the magnetic layer 20 formed in the first element body forming step S20.

In the outer electrode forming step S24, the method for forming each outer electrode is not limited to the example of the above embodiment. For example, copper plating is not required to be performed.

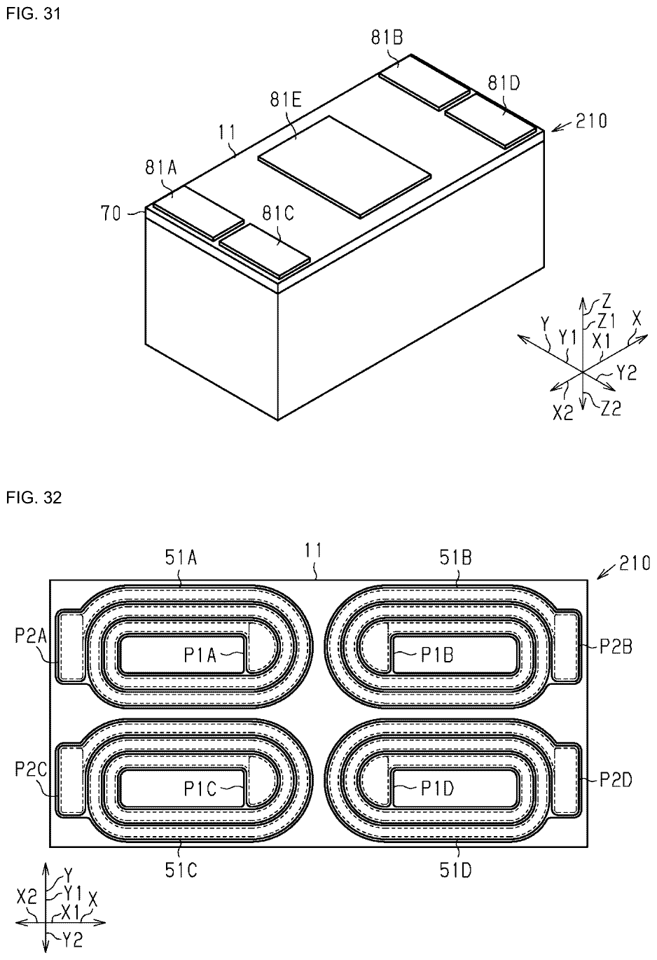

As in an example depicted in FIGS. 31 and 32, a specific outer electrode may be connected to a plurality of inductor wiring lines. An inductor component 210 depicted in FIG. 31 has five outer electrodes. Specifically, the inductor component 210 has the first outer electrode 81A on the first negative direction X2 side and the second positive direction Y1 side of the first main surface 11A of the element body 11. The inductor component 210 has the second outer electrode 81B on the first positive direction X1 side and the second positive direction Y1 side of the first main surface 11A. The inductor component 210 has the third outer electrode 81C on the first negative direction X2 side and the second negative direction Y2 side of the first main surface 11A. The inductor component 210 has the fourth outer electrode 81D on the first positive direction X1 side and the second negative direction Y2 side of the first main surface 11A. The inductor component 210 has a fifth outer electrode 81E at a position including substantially the geometric center of the first main surface 11A.

As depicted in FIG. 32, the inductor component 210 in the example of the modification has four inductor wiring lines 51. Specifically, the inductor component 210 has, inside the element body 11, a first inductor wiring line 51A on the first negative direction X2 side and the second positive direction Y1 side. The inductor component 210 has, inside the element body 11, a second inductor wiring line 51B on the first positive direction X1 side and the second positive direction Y1 side. The inductor component 210 has, inside the element body 11, a third inductor wiring line 51C on the first negative direction X2 side and the second negative direction Y2 side. The inductor component 210 has, inside the element body 11, a fourth inductor wiring line 51D on the first positive direction X1 side and the second negative direction Y2 side.

In this example of the modification, specifically, an outer pad portion P2A of the first inductor wiring line 51A is connected to the first outer electrode 81A. An outer pad portion P2B of the second inductor wiring line 51B is connected to the second outer electrode 81B. An outer pad portion P2C of the third inductor wiring line 51C is connected to the third outer electrode 81C. An outer pad portion P2D of the fourth inductor wiring line 51D is connected to the fourth outer electrode 81D. Further, an inner pad portion P1A of the first inductor wiring line 51A, an inner pad portion P1B of the second inductor wiring line 51B, an inner pad portion P1C of the third inductor wiring line 51C, and an inner pad portion P1D of the fourth inductor wiring line 51D are connected to the fifth outer electrode 81E. Accordingly, the fifth outer electrode 81E, which is one of the plurality of outer electrodes, is connected to both a first end of the first inductor wiring line 51A and a first end of the second inductor wiring line 51B. Thus, no potential difference is generated between the outer electrodes to which the respective inductor wiring lines are connected. An electronic component having such a configuration is suitable as, for example, an inductor used in a multi-phase DC/DC converter.

### Modifications of Second Embodiment

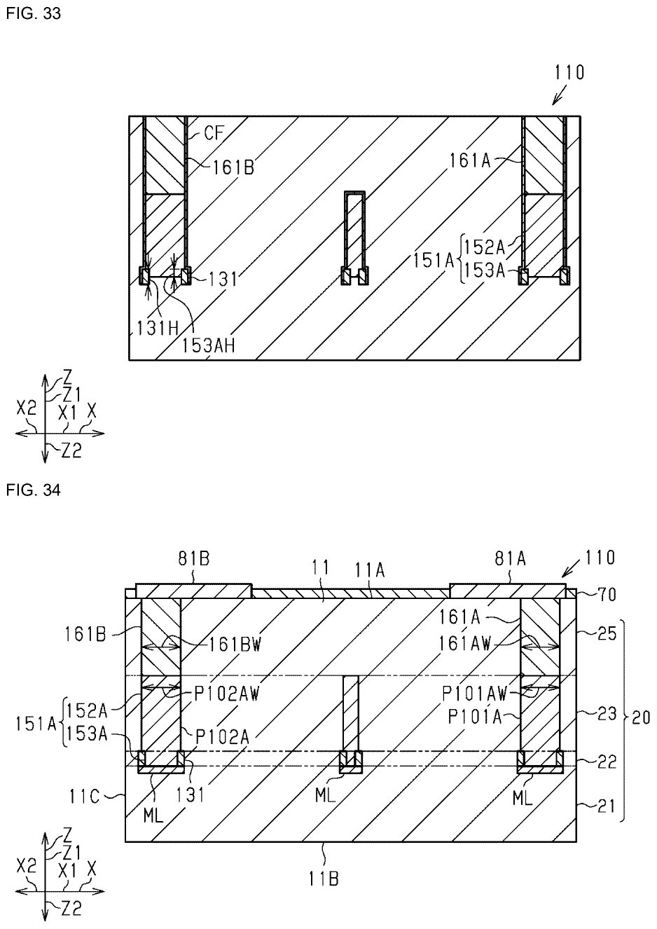

As depicted in FIG. 33, in the direction orthogonal to the first main surface 11A, a dimension 153AH of the first protruding portion 153A may be less than a dimension 131H of the first insulating layer 131. At this time, a tip of the first protruding portion 153A does not protrude beyond the first insulating layer 131 toward the third negative direction Z2 side. Therefore, even if a manufacturing error or the like occurs, the tip of each protruding portion is less likely to spread in a direction parallel to the first main surface 11A. As a result, it is possible to prevent the tip of the first protruding portion 153A from being short-circuited with another conductive portion that is not intended. This point is similarly applicable to the second protruding portion 153B.

As depicted in FIG. 33, the inductor component 110 may have an insulating coating CF that covers a side surface of the first inductor wiring line 151A, a surface that is not in contact with the first protruding portion 153A in a side surface of the first insulating layer 131, a side surface of the first columnar wiring line 161A, and a side surface of the second columnar wiring line 161B. This can enhance insulation between the inductor wiring lines and between the columnar wiring lines. This point is similarly applicable to the second inductor wiring line 151B.

The size of an end surface of each columnar wiring line on the third negative direction Z2 side may be smaller than the size of a surface on the third positive direction Z1 side in a pad portion to which the columnar wiring line is connected. At this time, when viewed in a cross section taken along the direction orthogonal to the first main surface 11A, in the direction parallel to the first main surface 11A, a difference between the dimension P101AW of the first end pad portion P101A of the first pad portions PA and the dimension 161AW of the first columnar wiring line 161A is preferably 20μm or less. Similarly, when viewed in a cross section taken along the direction orthogonal to the first main surface 11A, in the direction parallel to the first main surface 11A, a difference between the dimension P102AW of the second end pad portion P102A of the first pad portions PA and the dimension 161BW of the second columnar wiring line 161B is preferably 20μm or less.

Thus, even if some manufacturing error occurs between a position of the first dry film resist DFR1 and a position of the second dry film resist DFR2 in a manufacturing process for the inductor component 110, the columnar wiring line can be kept within the range of the corresponding pad portion.

However, even when the above difference is greater than 20μm, at least the effect described in (1-1) can be obtained because each wiring body has the protruding portion. This point is similarly applicable to the second pad portion PB.

As depicted in FIG. 33, the inductor component 110 is not required to include the outer electrode and the solder resist 70. At this time, for example, each columnar wiring line is only required to be exposed from the first main surface 11A. This can reduce the size of the inductor component 110. In a case of this example, a surface of the columnar wiring line on the third positive direction Z1 side functions as the outer electrode.

Each inductor wiring line and each columnar wiring line may be formed by omitting one or more steps selected from the first DFR forming step S115 and the second DFR forming step S117 and executing another step. For example, each columnar wiring line may be formed by, instead of executing the second DFR forming step S117, forming a support wall on an upper surface of each inductor wiring line and subsequently performing electrolytic plating.

Electrical conductivity at the outer surface of the first protruding portion 153A on the third negative direction Z2 side may be lower than electrical conductivity of the first wiring body 152A. For example, it is sufficient that a tip of the first protruding portion 153A be oxidized by heat treatment to reduce the electrical conductivity. This can enhance insulation between the first inductor wiring line 151A and the element body 11. The point is similarly applicable to the second protruding portion 153B.

The outer surface of the first protruding portion 153A on the third negative direction Z2 side is not required to be in contact with the element body 11. For example, as depicted in FIG. 34, the inductor component 110 may include a metal layer ML that covers the outer surface of the first protruding portion 153A on the third negative direction Z2 side. At this time, it is preferable that the metal layer ML extend along the first protruding portion 153A when the inductor component 110 is viewed in a see-through manner in the third positive direction Z1. For example, when nickel is selected as the material of the metal layer ML, oxidation of the outer surface of the first protruding portion 153A on the third negative direction Z2 side and deterioration of an outer surface of the first insulating layer 131 on the third negative direction Z2 side can be suppressed. The metal layer ML may be formed by, instead of executing the seed layer removing step S122, removing the base substrate 91 and etching the seed layer 93 to make a state in which the seed layer 93 covers the first protruding portion 153A. Further, it is preferable that electrical conductivity of the metal layer ML be lower than the electrical conductivity of the first wiring body 152A. This can enhance insulation between the first inductor wiring line 151A and the element body 11. These points are similarly applicable to the second protruding portion 153B.

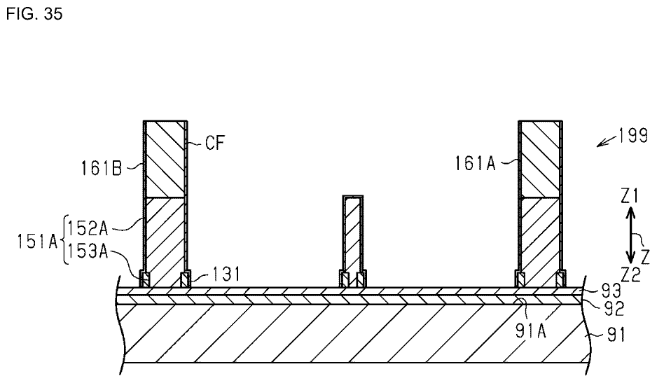

As depicted in FIG. 35, after the DFR removing step S119 and before the first element body forming step S120, a step of covering side surfaces of each inductor wiring line and each columnar wiring line with the insulating coating CF may be executed. It is sufficient that the insulating coating CF be deposited by, for example, chemical vapor deposition (CVD). This can enhance insulation between the inductor wiring lines and between the columnar wiring lines.

### SUPPLEMENTARY NOTES

Technical ideas derived from the above embodiments and modifications are described below.

[1] An inductor component comprising an element body that contains a magnetic material and has a main surface having a planar shape; an insulating layer that is located in the element body and extends on a plane parallel to the main surface; and an inductor wiring line that extends in the element body in parallel with the main surface. When one of directions orthogonal to the main surface is defined as a positive direction and a direction opposite to the positive direction is defined as a negative direction, the inductor wiring line includes a wiring body that extends on an outer surface of the insulating layer on the positive direction side, and a protruding portion that protrudes toward the negative direction side from an outer surface of the wiring body on the negative direction side. The outer surface of the wiring body on the negative direction side is in contact with the outer surface of the insulating layer on the positive direction side. When the inductor component is viewed in a see-through manner in the positive direction, the protruding portion is located within a range surrounded by an outer edge of the wiring body and extends along the wiring body, and when viewed in a cross section orthogonal to the main surface, a dimension of the protruding portion in a direction parallel to the main surface is smaller than a dimension, in the direction parallel to the main surface, of the wiring body at a location where the protruding portion is connected.

[2] The inductor component according to [1], wherein the wiring body and the protruding portion are monolithically-formed objects.

[3] The inductor component according to [1] or [2], wherein when an outer surface excluding the main surface and a surface on a side opposite to the main surface among outer surfaces of the element body is defined as a side surface of the element body, neither the inductor wiring line nor a conductive object electrically connected to the inductor wiring line is exposed at the side surface of the element body.

[4] The inductor component according to any one of [1] to [3], wherein an outer surface of the protruding portion on the negative direction side is in contact with the element body.

[5] The inductor component according to any one of [1] to [4], wherein electrical conductivity at an outer surface of the protruding portion on the negative direction side is lower than electrical conductivity of the wiring body.

[6] The inductor component according to any one of [1] to [3], further comprising a metal layer that covers an outer surface of the protruding portion on the negative direction side. When the inductor component is viewed in a see-through manner in the positive direction, the metal layer extends along the protruding portion.

[7] The inductor component according to [6], wherein electrical conductivity of the metal layer is lower than electrical conductivity of the wiring body.

[8] The inductor component according to any one of [1] to [7], wherein when an outer surface excluding an outer surface on the negative direction side among outer surfaces of the protruding portion is defined as a side surface, the side surface of the protruding portion is in contact with the insulating layer.

[9] The inductor component according to [8], wherein in the direction orthogonal to the main surface, a dimension of the protruding portion is less than a dimension of the insulating layer.

[10] The inductor component according to any one of [1] to [9], further comprising a columnar wiring line that is connected to an outer surface of the wiring body on the positive direction side and extends in the element body in a direction intersecting the main surface.

[11] The inductor component according to [10], wherein the columnar wiring line is in contact with the outer surface of the wiring body on the positive direction side.

[12] The inductor component according to [11], wherein the wiring body includes a wiring portion that extends in parallel with the main surface and a pair of pad portions connected to respective ends of the wiring portion, one end of the columnar wiring line is in contact with a surface of the pad portion that is parallel to the main surface. Also, when viewed in a cross section taken along the direction orthogonal to the main surface, in a direction parallel to the main surface, a difference between a dimension of the pad portion and a dimension of the columnar wiring line is 20μm or less.

[13] The inductor component according to any one of [10] to [12], wherein when an outer surface excluding the outer surface on the positive direction side and the outer surface on the negative direction side among outer surfaces of the wiring body is defined as a side surface of the wiring body, and an outer surface excluding an outer surface on the positive direction side and an outer surface on the negative direction side among outer surfaces of the columnar wiring line is defined as a side surface of the columnar wiring line, and an outer surface excluding the outer surface on the positive direction side and an outer surface on the negative direction side among outer surfaces of the insulating layer is defined as a side surface of the insulating layer, the inductor component further has an insulating coating that covers the side surface of the wiring body, the side surface of the columnar wiring line, and the side surface of the insulating layer.

[14] The inductor component according to any one of [1] to [13], wherein when the inductor wiring line is defined as a first inductor wiring line, the inductor component further includes a second inductor wiring line that is located in the same layer as the first inductor wiring line in the direction orthogonal to the main surface and extends in parallel with the main surface.

[15] The inductor component according to [14], further comprising a plurality of outer electrodes that cover part of an outer surface of the element body. Also, one of the plurality of outer electrodes is connected to both a first end of the first inductor wiring line and a first end of the second inductor wiring line.

[16] A manufacturing method for an inductor component, comprising a seed layer forming step of forming a seed layer having conductivity over a main surface of a base substrate; an insulating layer forming step of forming, on the seed layer, an insulating layer having an opening of a predetermined wiring pattern; a resin wall forming step of forming a resin wall on the insulating layer along an outer edge of the opening; and an inductor wiring line forming step of, by electrolytic plating performed by supplying power to the seed layer, forming a wiring body in a space surrounded by the resin wall and monolithically forming, in the opening, a protruding portion that protrudes from the wiring body and extends along the wiring body. The manufacturing method further comprises an element body forming step of forming a magnetic layer containing a magnetic material around the wiring body and the protruding portion after the inductor wiring line forming step; and a seed layer removing step of removing the seed layer after the element body forming step.

[17] A substrate for inductor component manufacturing, comprising a base substrate; a seed layer that is located over a main surface of the base substrate and has conductivity; an insulating layer that is located on the seed layer and is parallel to the main surface of the base substrate; and an inductor wiring line that is located on the insulating layer and extends in parallel with the main surface of the base substrate. When one of directions orthogonal to the main surface of the base substrate is defined as a positive direction and a direction opposite to the positive direction is defined as a negative direction, the inductor wiring line includes a wiring body that extends on an outer surface of the insulating layer on the positive direction side, and a protruding portion that protrudes toward the negative direction side from an outer surface of the wiring body on the negative direction side. Also, when viewed in the positive direction, the protruding portion extends along the wiring body, and a surface of the protruding portion on the negative direction side is in contact with the seed layer.

[18] The substrate for inductor component manufacturing according to [17], wherein a material of the seed layer is different from a material of the protruding portion.

[19] The substrate for inductor component manufacturing according to [17] or [18], further comprising an adhesive layer interposed between the base substrate and the seed layer. Also, a material of the adhesive layer is a resin having adhesiveness.

What is claimed is:

1. An inductor component comprising:
an element body that includes a magnetic material and has a main surface having a planar shape;
an insulating layer that is in the element body and extends on a plane parallel to the main surface; and
an inductor wiring line that extends in the element body in parallel with the main surface, wherein
when one of directions orthogonal to the main surface is defined as a positive direction and a direction opposite to the positive direction is defined as a negative direction,
the inductor wiring line includes
a wiring body that extends on an outer surface of the insulating layer on the positive direction side, and
a protruding portion that protrudes toward the negative direction side from an outer surface of the wiring body on the negative direction side,
the outer surface of the wiring body on the negative direction side is in contact with the outer surface of the insulating layer on the positive direction side,
when the inductor component is viewed in the positive direction, the protruding portion is within a range surrounded by an outer edge of the wiring body and extends along the wiring body, and
when viewed in a cross section orthogonal to the main surface, a dimension of the protruding portion in a direction parallel to the main surface is smaller than a dimension, in the direction parallel to the main surface, of the wiring body at a location where the protruding portion is connected.

2. The inductor component according to claim 1, wherein the wiring body and the protruding portion are monolithic objects.

3. The inductor component according to claim 1, wherein
when an outer surface excluding the main surface and a surface on a side opposite to the main surface among outer surfaces of the element body is defined as a side surface of the element body,
neither the inductor wiring line nor a conductive object electrically connected to the inductor wiring line is exposed at the side surface of the element body.

4. The inductor component according to claim 1, wherein
an outer surface of the protruding portion on the negative direction side is in contact with the element body.

5. The inductor component according to claim 1, wherein
electrical conductivity at an outer surface of the protruding portion on the negative direction side is lower than electrical conductivity of the wiring body.

6. The inductor component according to claim 1, further comprising:
a metal layer that covers an outer surface of the protruding portion on the negative direction side, wherein
when the inductor component is viewed in a see-through manner in the positive direction, the metal layer extends along the protruding portion.

7. The inductor component according to claim 6, wherein
electrical conductivity of the metal layer is lower than electrical conductivity of the wiring body.

8. The inductor component according to claim 1, wherein
when an outer surface excluding an outer surface on the negative direction side among outer surfaces of the protruding portion is defined as a side surface,
the side surface of the protruding portion is in contact with the insulating layer.

9. The inductor component according to claim 8, wherein
in the direction orthogonal to the main surface, a dimension of the protruding portion is less than a dimension of the insulating layer.

10. The inductor component according to claim 1, further comprising:
a columnar wiring line that is connected to an outer surface of the wiring body on the positive direction side and extends in the element body in a direction intersecting the main surface.

11. The inductor component according to claim 10, wherein
the columnar wiring line is in contact with the outer surface of the wiring body on the positive direction side.

12. The inductor component according to claim 11, wherein
the wiring body includes a wiring portion that extends in parallel with the main surface and a pair of pad portions connected to respective ends of the wiring portion,
one end of the columnar wiring line is in contact with a surface of the pad portion that is parallel to the main surface, and
when viewed in a cross section taken along the direction orthogonal to the main surface, in a direction parallel to the main surface, a difference between a dimension of the pad portion and a dimension of the columnar wiring line is 20 μm or less.

13. The inductor component according to claim 10, wherein
when an outer surface excluding the outer surface on the positive direction side and the outer surface on the negative direction side among outer surfaces of the wiring body is defined as a side surface of the wiring body, and
an outer surface excluding an outer surface on the positive direction side and an outer surface on the negative direction side among outer surfaces of the columnar wiring line is defined as a side surface of the columnar wiring line, and
an outer surface excluding the outer surface on the positive direction side and an outer surface on the negative direction side among outer surfaces of the insulating layer is defined as a side surface of the insulating layer,
the inductor component further has an insulating coating that covers the side surface of the wiring body, the side surface of the columnar wiring line, and the side surface of the insulating layer.

14. The inductor component according to claim 1, wherein
when the inductor wiring line is defined as a first inductor wiring line,
the inductor component further includes a second inductor wiring line that is in the same layer as the first inductor wiring line in the direction orthogonal to the main surface and extends in parallel with the main surface.

15. The inductor component according to claim 14, further comprising:
a plurality of outer electrodes that cover part of an outer surface of the element body, wherein one of the plurality of outer electrodes is connected to both a first end of the first inductor wiring line and a first end of the second inductor wiring line.

16. The inductor component according to claim 2, wherein
when an outer surface excluding the main surface and a surface on a side opposite to the main surface among outer surfaces of the element body is defined as a side surface of the element body,
neither the inductor wiring line nor a conductive object electrically connected to the inductor wiring line is exposed at the side surface of the element body.

17. A manufacturing method for an inductor component, comprising:
forming a seed layer having conductivity over a main surface of a base substrate;
forming, on the seed layer, an insulating layer having an opening of a predetermined wiring pattern;
forming a resin wall on the insulating layer along an outer edge of the opening;
forming an inductor wiring line by forming, by electrolytic plating performed by supplying power to the seed layer, a wiring body in a space surrounded by the resin wall and monolithically forming, in the opening, a protruding portion that protrudes from the wiring body and extends along the wiring body;
forming a magnetic layer including a magnetic material around the wiring body and the protruding portion after the forming an inductor wiring line;
forming an element body; and
removing the seed layer after the forming an element body.

18. A substrate for inductor component manufacturing, comprising:
a base substrate;
a seed layer that is over a main surface of the base substrate and has conductivity;
an insulating layer that is on the seed layer and is parallel to the main surface of the base substrate; and
an inductor wiring line that is on the insulating layer and extends in parallel with the main surface of the base substrate, wherein when one of directions orthogonal to the main surface of the base substrate is defined as a positive direction and a direction opposite to the positive direction is defined as a negative direction,
the inductor wiring line includes
a wiring body that extends on an outer surface of the insulating layer on the positive direction side, and
a protruding portion that protrudes toward the negative direction side from an outer surface of the wiring body on the negative direction side,
when viewed in the positive direction, the protruding portion extends along the wiring body, and
a surface of the protruding portion on the negative direction side is in contact with the seed layer.

19. The substrate for inductor component manufacturing according to claim 18, wherein
a material of the seed layer is different from a material of the protruding portion.

20. The substrate for inductor component manufacturing according to claim 18, further comprising:
an adhesive layer interposed between the base substrate and the seed layer, wherein
a material of the adhesive layer is a resin having adhesiveness.
